(19) United States
(12) Patent Application Publication
(10) Pub. No.: US 2026/0289088 A1
(43) Pub. Date: Sep. 24, 2026

(54) SYSTEM

(71) Applicant: SoftBank Group Corp., Tokyo (JP)

(72) Inventor: Yoshiko SHIMIZU, Tokyo (JP)

(73) Assignee: SoftBank Group Corp., Tokyo (JP)

(21) Appl. No.: 19/567,345

(22) Filed: Mar. 16, 2026

(30) Foreign Application Priority Data
Mar. 19, 2025 (JP) 2025-045284

(51) Int. Cl. G06F 40/166; G06F 40/103; G06F 40/253; G06F 40/284; G06F 40/295; G06F 40/40; G06N 3/0475; G06V 40/16; G10L 25/63

(52) U.S. Cl. CPC G06F 40/166; G06F 40/103; G06F 40/253; G06F 40/284; G06F 40/295; G06F 40/40; G06N 3/0475; G06V 40/174; G10L 25/63

(57) ABSTRACT

A system includes a processor that is configured to analyze a text of a finished story and generate a prompt for instructing a generative AI model to generate a continuation of the story, generate the continuation of the story by using the generative AI model with the generated prompt as input, and recognize, in real time, an emotion of a user and dynamically adjust a development of the story in accordance with the emotion of the user.

### CROSS-REFERENCE TO RELATED APPLICATION

This application is based on and claims priority under 35 USC 119 from Japanese Patent Application No. 2025-045284 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional story generation systems using generative AI models mainly focus on statically generating a story continuation or an alternative story based on a fixed input text, such as a finished novel, comic, or script. Such systems generally do not consider a user's emotional state during story consumption and therefore cannot dynamically adapt the story development in real time. As a result, the generated stories are often limited in personalization, and user engagement and immersion remain insufficient because the narrative cannot be responsively adjusted according to the user's changing emotions. Furthermore, although some systems can generate side stories or alternative scenarios, they typically do not analyze minor characters who appeared in a finished story but did not have a major role, nor do they generate new stories from the perspective of such characters in a systematic manner. Consequently, opportunities to provide novel viewpoints or to expand the original story world in a way that reflects user interest are not fully realized.

In addition, even when a generative AI model is used for story generation, conventional techniques do not explicitly integrate real-time emotion recognition data into the story generation process. The story is usually generated in a single pass based solely on the input text and prompt, without iterative or dynamic adjustment based on emotional feedback from the user. Therefore, there is a need for a system capable of: (i) analyzing a finished story, (ii) generating appropriate prompts for a generative AI model, (iii) generating continuations or new viewpoint stories, and (iv) dynamically adjusting the development of the story in real time based on emotion data recognized from the user, in order to enhance personalization, engagement, and emotional resonance of the generated narrative.

### SUMMARY

To solve the above-described problems, according to one aspect of the present invention, there is provided a system comprising a processor, wherein the processor is configured to analyze a text of a finished story and generate a prompt for instructing a generative AI model to generate a continuation of the story, generate the continuation of the story by using the generative AI model with the generated prompt as input, and recognize, in real time, an emotion of a user and dynamically adjust a development of the story in accordance with the emotion of the user. By structuring the processor in this manner, the system not only automatically creates a narrative continuation consistent with the original story but also adaptively modifies the narrative flow during playback or reading, thereby providing a personalized storytelling experience that responds to the user's emotional state. According to another aspect of the present invention, the processor is further configured to analyze a character who appears in the finished story but does not have a major role, and generate a prompt for instructing the generative AI model to generate a story from a new viewpoint with the character as a protagonist. By performing such analysis and prompt generation, the system can automatically derive side stories or spin-off narratives focusing on minor characters, thereby expanding the original story world and offering the user fresh perspectives on familiar works without requiring manual scenario design for each character. According to still another aspect of the present invention, the processor is configured to adjust the development of the story, when generating the story based on the prompt by using the generative AI model, by taking into account emotion data obtained from an emotion recognition means of the user. The emotion recognition means may include, for example, sensors, cameras, microphones, or software modules that detect facial expressions, voice tone, physiological signals, or interaction patterns. By feeding such emotion data back into the story generation process, the processor can instruct the generative AI model to change the pacing, tone, or direction of the narrative, such as shifting toward more exciting, relaxing, or empathetic scenes according to the user's detected emotional state. In this way, the combination of prompt generation based on a finished story, viewpoint selection including minor characters, and real-time emotion-aware narrative adjustment enables a highly adaptive and immersive story generation system.

The term “processor” refers to one or more hardware processing units, such as a CPU, GPU, or dedicated accelerator, and may include associated memory and control circuitry configured to execute instructions for performing the described analysis, prompt generation, story generation, and emotion-based adjustment functions. The term “finished story” refers to a narrative work, such as a novel, comic, script, or other textual story content, for which the original author's main storyline has been completed, including its ending, and which is used as a source for generating a continuation or a new viewpoint story.

The term “text of a finished story” refers to the textual data representing at least a part of the finished story, including, for example, the entire story, one or more chapters, scenes, or segments of the story, which is provided to the processor as input for analysis.

The term “generative AI model” refers to a machine learning model, such as a large language model, configured to generate natural language text based on an input prompt, and capable of producing new sentences, paragraphs, or narratives that are not simple copies of the input text.

The term “prompt” refers to a text or structured input generated by the processor and provided to the generative AI model, the prompt including instructions, context, and conditions that guide the generative AI model to generate a desired story continuation or new viewpoint story.

The term “continuation of the story” refers to one or more narrative segments, such as subsequent chapters, scenes, or episodes, that extend the plot, events, or character development beyond the ending or last portion of the finished story in a manner consistent with or intentionally derived from the original story.

The term “recognize, in real time, an emotion of a user” refers to detecting and identifying a current emotional state of the user, such as happiness, sadness, fear, surprise, anger, or calmness, substantially contemporaneously with the user's consumption of the story, based on signals obtained from sensors or interaction data.

The term “dynamically adjust a development of the story” refers to modifying, during or between generation steps, at least one aspect of the narrative, such as plot direction, pacing, tone, intensity, or character behavior, in response to external input, including the recognized emotion of the user.

The term “character who appears in the finished story but does not have a major role” refers to a character that is present in the narrative of the finished story but is not the main protagonist or primary antagonist, and whose involvement in the original plot is limited compared to major characters.

The term “story from a new viewpoint” refers to a narrative that is generated to present events, settings, or relationships from a perspective different from that of the original protagonist of the finished story, for example, by using a minor character as the focal character or narrator.

The term “protagonist” refers to a character designated as the main focal character of the generated story, whose actions, thoughts, and experiences primarily drive the narrative in the generated continuation or new viewpoint story.

The term “emotion data” refers to information representing one or more emotional states of the user, which is obtained from an emotion recognition means and may include numerical values, categorical labels, confidence scores, or time-series data indicating changes in the user's emotions.

The term “emotion recognition means” refers to hardware and/or software components configured to detect and estimate the user's emotional state, including, for example, cameras for facial expression analysis, microphones for voice tone analysis, physiological sensors, or interaction-logging modules, and algorithms that process such data to infer emotions.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

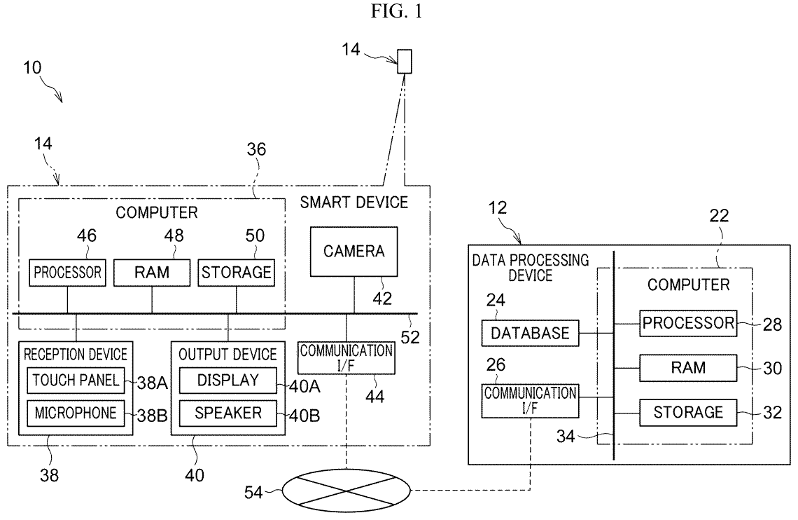

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

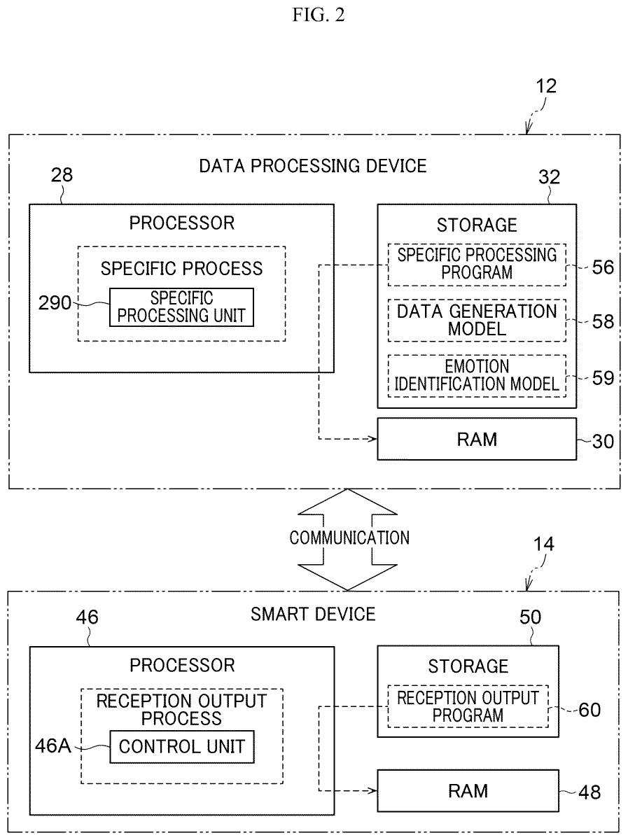

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented story generation systems typically accept a simple user instruction and directly invoke a generative AI model to produce a continuation of a given text. Such systems generally do not perform structured linguistic analysis of the final part of a completed document, and therefore fail to robustly capture subject-level context, relationships among entities, and narrative constraints that are important for coherent continuation. As a result, conventional systems frequently generate output that is inconsistent with existing character relationships, drifts away from established themes, or contradicts key events in the completed document.

Moreover, existing architectures often treat the generative AI model as a black box, passing an unstructured prompt and relying on post hoc manual curation, which limits the ability of the computer system itself to control narrative development, style, and length in a systematic, machine-enforceable manner. These systems rarely integrate a pipeline that transforms raw final-part text into structured analysis information, and then programmatically composes a prompt sentence that explicitly encodes subject information, entity-relationship information, and summary information as machine-readable constraints for the generative AI model. This lack of structure leads to unstable generation quality and hinders reproducible behavior across different runs and different users.

In addition, conventional systems typically ignore the real-time emotional state of the user. Even when user feedback is collected, it is generally used in a coarse, offline manner, rather than being captured as emotion-state information that is dynamically fed into the generation pipeline. As a consequence, such systems cannot adapt story development, writing style, and narrative length based on the user's emotional responses during interaction, and therefore cannot provide a responsive, user-centered storytelling experience in which the computer system actively modulates output according to the user's emotional state.

Further, existing systems do not exploit low-prominence entities—such as minor characters or peripheral elements identified in the final part of a completed document—as computational levers for generating new viewpoints. Without structured identification and promotion of such low-prominence entities, it is difficult for the computer system to systematically produce alternative narrative perspectives (for example, side stories or spin-offs) in a controlled and repeatable manner using a generative AI model.

Accordingly, there is a need for an improved computer-implemented story generation technique in which a processor: (i) acquires and linguistically analyzes final-part text data of a completed document to produce structured analysis information; (ii) constructs a prompt sentence that encodes subject information, entity-relationship information, summary information, and viewpoint information for a generative AI model; (iii) controls the interaction with an external generative AI model based on such structured prompt information and generation conditions; (iv) performs automated formatting and content checking of generated-document text data; and (v) dynamically modifies the prompt sentence and generation conditions based on emotion-state information of the user, including cases where low-prominence entities are computationally elevated to main entities. There is also a need for a server-side architecture that implements these steps as a coordinated pipeline to improve determinism, coherence, and personalization of AI-generated story continuations, thereby improving the functioning of the computer system itself in the field of natural language generation.

The specific processing by the specific processing unit 290 of the data processing device 12 in Example 1 is realized by the following means.

The present invention provides a server comprising a processor and a memory storing instructions which, when executed by the processor, cause the processor to acquire final-part text data of a completed document from a storage medium based on identification information of the completed document, analyze the final-part text data using a natural language processing algorithm to generate analysis information including at least subject information of the completed document and relationship information between appearing entities, construct a prompt sentence for a generative AI model based on the analysis information and the final-part text data, the prompt sentence including at least a title of the completed document, the subject information, the relationship information, and summary information of the final-part text data, transmit the prompt sentence and generation conditions to an external generative AI model via a communication interface and acquire generated-document text data that is a continuation of the completed document from the external generative AI model, execute formatting processing and content-checking processing on the generated-document text data to generate display-structured data and transmit the display-structured data to a terminal device, obtain emotion-state information of a user by using an emotion recognition function, and modify, based on the emotion-state information, at least one of the prompt sentence and the generation conditions so as to adjust at least one of narrative development, writing style, and length of the generated-document text data, including identifying a low-prominence entity among the appearing entities based on occurrence frequency, incorporating viewpoint information centered on the low-prominence entity into the analysis information, and controlling the generative AI model via the prompt sentence so that the generated-document text data is generated as a document from a new viewpoint in which the low-prominence entity is treated as a main entity. This enables the computer system to programmatically transform raw final-part text into structured analysis information, encode such information into a machine-constructed prompt sentence, dynamically incorporate user emotion-state information, and thereby control the generative AI model to produce coherent, contextually consistent, and emotionally adaptive story continuations, improving the technical performance and controllability of computer-based natural language generation.

The term “completed document” refers to a document whose narrative or content has reached an endpoint, such that no further original continuation is provided by an author, and which serves as a source text for generating additional content.

The term “final-part text data” refers to text data representing a terminal portion of the completed document, including a final chapter, section, or segment, that is used as an input for analysis and generation of a continuation.

The term “identification information” refers to information used to uniquely or quasi-uniquely identify a completed document in a storage system, such as a title, an identifier, a key, or a combination thereof.

The term “storage medium” refers to any hardware device configured to store digital data, such as a semiconductor memory, a magnetic storage device, or an optical storage device.

The term “natural language processing algorithm” refers to a computer-implemented procedure that analyzes text expressed in a human language to extract linguistic, semantic, or structural features, including but not limited to tokenization, part-of-speech tagging, parsing, entity recognition, summarization, or topic extraction.

The term “analysis information” refers to structured data derived from the final-part text data by the natural language processing algorithm, the structured data including at least subject information and relationship information between appearing entities.

The term “subject information” refers to data indicating one or more main themes, topics, or central ideas of the completed document as inferred from the final-part text data.

The term “appearing entity” refers to an element identified in the final-part text data, such as a character, object, place, organization, or concept, that participates in or is referenced by the narrative or content.

The term “relationship information” refers to data representing associations between appearing entities, including but not limited to roles, interactions, affinities, conflicts, or hierarchical relationships.

The term “prompt sentence” refers to an instruction sentence or instruction text that is composed by the processor and provided as input to a generative AI model in order to control generation of output text.

The term “generative AI model” refers to a trained artificial intelligence model configured to generate text or other content based on input data such as a prompt sentence, including but not limited to probabilistic language models and neural network-based generative models.

The term “generation conditions” refers to parameters used to control behavior of the generative AI model, including but not limited to output length, temperature, style, tone, or constraints on narrative development.

The term “external generative AI model” refers to a generative AI model that is executed on a device, service, or computing resource separate from the server, and is accessed by the server via a communication interface.

The term “communication interface” refers to hardware, software, or a combination thereof that enables data exchange between the server and another device or service, including network interfaces and communication protocols.

The term “generated-document text data” refers to text data output by the generative AI model as a result of processing the prompt sentence and the generation conditions, the text data representing a continuation or alternative narrative of the completed document.

The term “formatting processing” refers to processing that converts raw generated-document text data into a presentation-ready form, including operations such as paragraph structuring, insertion of headings, or adjustment of line breaks and spacing.

The term “content-checking processing” refers to processing that evaluates the generated-document text data for compliance with predetermined criteria, such as coherence, length, or content policies, and may include filtering, modification, or rejection of portions of the text.

The term “display-structured data” refers to data formatted for presentation on a user interface, including text, layout information, and associated metadata used by a terminal device to render content on a display.

The term “terminal device” refers to an end-user computing device configured to communicate with the server and to present content to a user, such as a smartphone, tablet, personal computer, or similar device.

The term “display device” refers to a hardware component of the terminal device configured to visually present information, such as a liquid crystal display, an organic light-emitting diode display, or another screen.

The term “operation input” refers to user-generated input, such as touch input, mouse input, keyboard input, or gesture input, that is received by the terminal device and processed by the server or the terminal device.

The term “emotion-state information” refers to information representing an estimated emotional state of a user, such as happiness, sadness, excitement, or calmness, obtained by an emotion recognition function.

The term “emotion recognition function” refers to a function implemented by hardware, software, or a combination thereof that estimates the emotional state of a user based on input data such as facial images, voice signals, physiological signals, or user interactions.

The term “low-prominence entity” refers to an appearing entity whose prominence, as indicated by metrics such as occurrence frequency or narrative emphasis, is lower than that of one or more other appearing entities in the final-part text data.

The term “viewpoint information” refers to data indicating a narrative perspective or focus, such as centering the narrative around a particular entity, role, or position in the story.

The term “new viewpoint” refers to a narrative perspective that differs from an original primary perspective of the completed document, for example by treating a low-prominence entity as a main entity.

The term “main entity” refers to an entity that is treated as central or primary in the generated-document text data, such as a principal character or focal element of the narrative.

The term “narrative development” refers to progression of events, plot, or storyline in the generated-document text data, including introduction, escalation, and resolution of narrative elements.

The term “writing style” refers to characteristics of the generated text such as tone, formality, vocabulary choice, pacing, and syntactic patterns.

The term “length” refers to a quantitative measure of the generated-document text data, such as a number of characters, words, tokens, sentences, or paragraphs.

In one embodiment, a server, a terminal, and a user cooperate to implement the claimed system. The server comprises at least one processor, a main memory, a non-volatile storage device such as a solid-state drive, and a network interface. The terminal comprises a processor, a memory, a display device such as a liquid crystal display or an organic light-emitting diode display, and an input device such as a touchscreen. The server and the terminal communicate over a network using a wired or wireless communication link, such as Ethernet, Wi-Fi, or a mobile communication network.

The server stores, in the non-volatile storage device, a document database including completed documents, each document being associated with identification information such as a title or an identifier. The server further stores software modules implementing a natural language processing pipeline, a prompt-construction engine, a generative AI model client, a content-checking engine, an emotion-recognition interface, and a presentation formatter. In one example, the natural language processing pipeline is implemented using a software framework such as spaCy or a transformer-based library, and the server executes these modules on the processor using an operating system such as a general-purpose server operating system.

The server analyzes final-part text data of a completed document by executing the natural language processing pipeline in the main memory. The server loads the final-part text data as a sequence of characters and converts the characters into tokens using a tokenizer. The server assigns part-of-speech tags to the tokens and computes syntactic dependency relationships to obtain sentence structures. The server detects entities by applying a named entity recognition algorithm, which uses a trained statistical model or a neural network model to assign entity labels such as person, location, or organization to spans of tokens. The server further computes co-occurrence statistics of the entities across sentences or paragraphs and calculates relationship scores between pairs of entities, for example based on proximity in dependency trees and co-occurrence frequencies. The server stores these results as analysis information in a structured data format such as key-value pairs in memory.

The server identifies subject information of the completed document by executing a topic extraction or summarization procedure. The server computes word or token embeddings using a pre-trained transformer-based encoder and applies a clustering or attention-based summarization algorithm to obtain one or more vectors representing main themes. The server converts these vectors into human-readable subject information by selecting representative tokens or phrases. The server aggregates the subject information together with the relationship information into the analysis information. By structuring the analysis information in this way, the server reduces ambiguity in subsequent generation and enables the generative AI model to receive explicit constraints derived from the final part of the document.

The server constructs a prompt sentence based on the analysis information and the final-part text data. The server creates a template that includes slots for a title of the document, subject information, relationship information between appearing entities, and summary information of the final-part text data. The server fills the slots by converting the structured analysis information into natural language phrases. The server concatenates the phrases with the final-part text data to form a prompt sentence suitable for input to a generative AI model. In one example, the server generates a prompt sentence such as:
“Title: Novel A
Main characters: Alice, Bob
Relationships: Alice and Bob are close allies who trust each other deeply.
Themes: friendship, sacrifice
Here is the final part of the finished story:
[final-part text]
Based on the above, continue the story as the next chapter in Japanese, keeping the same tone and character relationships, and targeting a medium length.”

In another example, the server constructs a prompt sentence:
“Title: The Last Kingdom
Main characters: Edrin (king), Lyra (sorceress)
Relationships: Edrin and Lyra are loyal allies with unresolved romantic tension.
Themes: duty, betrayal, redemption
Here is the final chapter of the finished story:
[final-part text]
Based on this information, continue the story as Chapter 12 in English. Keep the dark fantasy tone, do not contradict existing relationships, and introduce one new political conflict. Target length: about 1,500 words.”

The server then uses a generative AI model client module to send the prompt sentence and generation conditions to an external generative AI model executed on a remote computing resource. The generative AI model may be implemented as a large-scale neural network, such as a transformer-based language model having multiple self-attention layers, feedforward layers, and embedding layers. The generative AI model is typically trained in advance using a large corpus of text, a loss function such as cross-entropy error on next-token prediction, and an optimization algorithm such as stochastic gradient descent with adaptive moment estimation. The generative AI model uses learned weight parameters to compute, for each token position, a probability distribution over a vocabulary, conditioned on previous tokens and on the prompt sentence.

The server specifies generation conditions, such as maximum output tokens, temperature, top-k or top-p sampling parameters, and penalties for repetition. The server includes these parameters in the data sent over the communication interface. The generative AI model, upon receiving the prompt sentence and generation conditions, repeatedly computes attention weights, applies linear transformations and nonlinear activation functions across its layers, and outputs a sequence of tokens representing the continuation of the document. The server receives the generated-document text data as a sequence of tokens or a string and stores it in the main memory.

The server differs from a simple automation of human tasks because the server does not merely replace manual writing with automatic generation. Instead, the server implements a structured computational pipeline that reorganizes and constrains the generative process at the data-structure and algorithmic level. For example, the server converts unstructured final-part text into structured analysis information, encodes the information into a prompt sentence with explicit subject and relationship constraints, and uses machine-readable generation conditions to control the external model's decoding algorithm. This pipelined architecture improves story coherence and thematic consistency compared with naive prompting and provides deterministic, repeatable control over generation that a human operator could not achieve at similar scale or speed.

The server performs content-checking processing on the generated-document text data to improve quality and reduce errors. The server applies rule-based checks and statistical checks. For rule-based checks, the server scans the generated text for prohibited terms or patterns and removes or replaces segments that violate content policies. For statistical checks, the server can run a separate classifier model trained to detect incoherent or off-topic content, and the server discards or regenerates suspicious segments. The server then executes formatting processing, such as inserting paragraph breaks at sentence boundaries, adding a chapter heading, and normalizing whitespace. The server arranges the processed text as display-structured data, comprising text segments, layout metadata, and identifiers, and stores it as a data object ready for transmission to the terminal.

The terminal receives the display-structured data and renders the generated-document text data on the display device. The terminal uses a graphical user interface framework to lay out text lines, scrollbars, and control buttons. The terminal may, for example, display a chapter title at the top of the screen, show the body text in a scrollable area, and provide buttons for regenerating the continuation or changing preferences. The terminal's processor converts the structured layout information into rendering commands for the display controller and may utilize graphics processing hardware to accelerate text rendering. The user views the displayed text on the display device and operates the input device to scroll, navigate between sections, or request regeneration.

The server obtains emotion-state information of the user by interfacing with an emotion recognition function. In one embodiment, the terminal captures user signals, such as face images from a camera or voice signals from a microphone, and transmits feature data to the server. The server executes an emotion recognition model, for example a convolutional neural network for facial expressions or a recurrent neural network for prosodic features, which has been trained using supervised learning on labeled emotion datasets. The emotion recognition model computes an emotion label or a continuous emotion vector from the input features by minimizing an error function such as cross-entropy or mean squared error during training, and by applying the learned weights during inference.

The server maps the emotion-state information to adjustments of the prompt sentence and generation conditions. For instance, if the user is estimated to be bored or disengaged, the server increases a parameter related to narrative intensity and instructs the generative AI model to introduce more conflict or suspense in subsequent text. If the user is estimated to be distressed, the server decreases the intensity of negative events or shortens scenes of conflict by adjusting generation conditions such as temperature and maximum length and by adding explicit constraints to the prompt sentence. In this way, the server uses emotion-state information not as an abstract control signal but as a parameter that alters the generative model's token selection probabilities and narrative constraints. This dynamic modification achieves a technically improved adaptive control loop, resulting in reduced user drop-off and more stable engagement patterns, which can be quantified through log analysis of interaction data.

The server further identifies low-prominence entities among the appearing entities by computing occurrence frequency statistics from the final-part text data. The server calculates, for each entity, a frequency count and a prominence score that may also incorporate positional importance or syntactic role. When the server detects an entity whose prominence score is below a threshold but above a minimum relevance level, the server marks the entity as a candidate low-prominence entity. The server inserts viewpoint information centered on the low-prominence entity into the analysis information and constructs a prompt sentence that instructs the generative AI model to treat the low-prominence entity as a main entity in the generated-document text data. For example, the server may generate a prompt sentence such as:
“Title: Mystery B
Minor character: John, a quiet neighbor who appeared briefly in the final chapter.
New viewpoint: Tell the story from John's perspective, revealing how he interpreted the events.
Here is the final part of the finished story:
[final-part text]
Write a new chapter that reinterprets the same events from John's viewpoint, without contradicting the original plot.”

By systematically redefining the viewpoint in this non-conventional manner based on quantitative prominence metrics, the server achieves a novel generation mode that extends beyond usual human practice of manually selecting viewpoints. This process causes the generative AI model to follow a rule-based viewpoint shift dictated by the structured prompt sentence, thereby enabling consistent generation of alternative perspectives across multiple documents and users. As a result, the server improves the diversity of generated outputs while maintaining narrative consistency, which can be measured by comparing overlap of entities and events between original and generated texts.

The server improves computational efficiency by reusing intermediate analysis information across multiple generations. For example, the server maintains a cache of analysis information keyed by document identification information and final-part hash values. When a subsequent request targets the same final-part text data but different generation conditions, the server retrieves the cached analysis information instead of re-running the entire natural language processing pipeline. This reuse reduces CPU time consumption and shortens latency for the user. The server also manages communication load by compressing prompt sentences and generated text data and by batching multiple generation requests into a single communication session when possible, thereby reducing network overhead and improving throughput.

The server utilizes modular data structures to represent analysis information, prompt sentences, generation conditions, and display-structured data. By strictly separating these data structures, the server can apply static checks on each structure before passing it to the next stage, thereby detecting errors earlier and preventing propagation of malformed data. This modular architecture also enables parallelization of processing steps across multiple processor cores, further improving processing speed. For instance, the server can simultaneously perform emotion recognition and final-part analysis in different threads, then merge their results into a single prompt sentence. Such parallel processing constitutes a technical improvement over sequential, human-centric methods.

The server, by implementing these concrete data structures and processing flows, improves the functioning of the computer system in the field of natural language generation. The system reduces the computational cost of achieving coherent, context-sensitive narrative continuations compared with naïve repeated calls to a generative AI model. The system also enhances precision in meeting user-specified narrative constraints and emotional preferences by embedding structured analysis information and emotion-state information directly into the model's input representation, instead of relying solely on unstructured natural language prompts. The result is a concrete improvement in accuracy of narrative coherence, reduction in contradictions with the source document, and enhancement of user satisfaction as measured by objective metrics such as reduced regeneration rate and increased reading completion rate.

In alternative embodiments, the server may employ different natural language processing libraries, different neural network architectures for the generative AI model and the emotion recognition function, different data storage technologies, or different communication protocols. The server may be integrated with the terminal in a single device, or may be distributed across multiple servers in a cloud environment. The generative AI model may be executed entirely by the server, without external access, in which case the server hosts both the analysis and generation functions. The system may use alternative prominence metrics, such as attention-based importance scores from the generative AI model, instead of or in addition to occurrence frequency. The system may also support multiple languages by selecting corresponding language-specific tokenizers and models.

Through these embodiments and variations, the server, the terminal, and the user cooperate in a technical framework that goes beyond business logic or mere automation of writing tasks. The described system implements specialized data structures, non-conventional processing sequences, and learned neural models to provide a technically improved, adaptive, and efficient story generation platform based on a generative AI model and a structured prompt sentence.

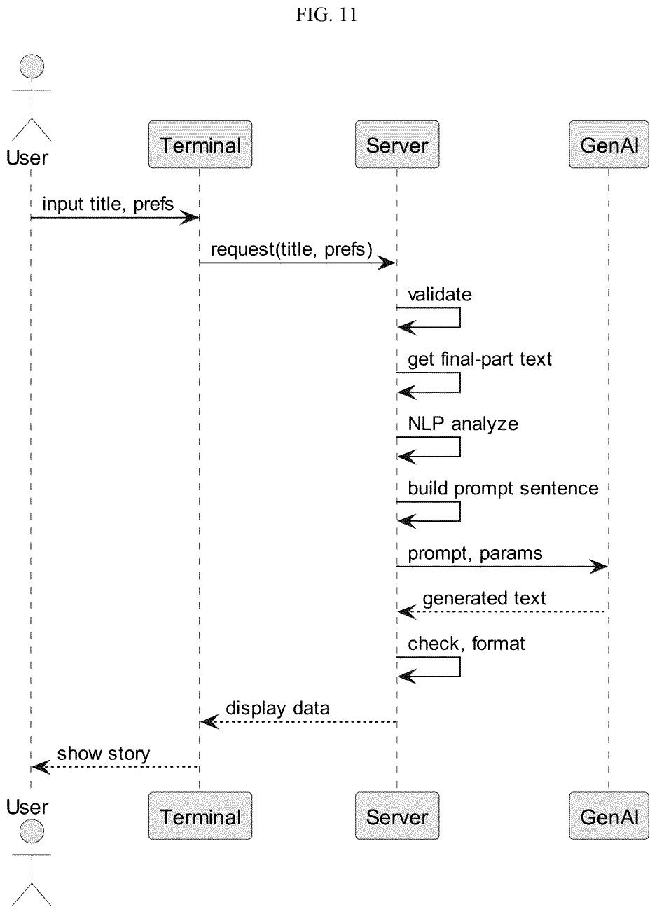

The following describes the processing flow using FIG. 11.

### Step 1:

The user operates the terminal to open an application screen for sequel generation and inputs identification information of a completed document, such as a title or an ID, into a text input field. The input of this step is the identification information and optional preference parameters (for example, desired length and tone) entered by the user. The terminal reads these values from its user interface components, stores them in local memory, and packages them into a structured request object. The terminal then outputs an HTTP or similar network request containing the identification information and the preference parameters addressed to the server.

### Step 2:

The server receives the network request from the terminal through a communication interface and parses the request to extract the identification information and the preference parameters. The input of this step is the incoming request message. The server performs data validation operations, such as checking that the identification information is not empty and that the preference parameters fall within predefined ranges. Based on this processing, the server outputs a validated internal representation of the request, for example a data structure that contains a normalized document identifier, a sanitized title string, and normalized preference values.

### Step 3:

The server uses the validated document identifier to query a storage medium that stores digital text of completed documents. The input of this step is the normalized identifier or title. The server executes a database lookup operation, for example issuing an SQL query or a key-value lookup, to retrieve the final-part text data of the completed document. The server may also compute or verify a checksum of the retrieved data to ensure integrity. The server then outputs the final-part text data as a text string or sequence of tokens in memory; if no matching record is found, the server outputs an error condition.

### Step 4:

The server analyzes the final-part text data by executing a natural language processing pipeline. The input of this step is the final-part text data. The server applies tokenization to split the text into tokens, applies part-of-speech tagging and syntactic parsing to each sentence, and runs named entity recognition to detect appearing entities such as characters and locations. The server also calculates co-occurrence statistics and syntactic proximity metrics between entities to infer relationship information. In addition, the server computes subject information by executing topic extraction or summarization algorithms based on word or sentence embeddings. As a result of these data processing operations, the server outputs analysis information that includes at least subject information, relationship information between appearing entities, and optional summary information of the final part.

### Step 5:

The server identifies low-prominence entities within the appearing entities using occurrence frequency and other prominence metrics. The input of this step is the set of appearing entities and their statistics derived in the analysis information. The server computes, for each entity, a prominence score based on the number of mentions, their positions in the text, and their syntactic roles, and compares these scores to one or more thresholds. The server selects entities whose scores indicate lower prominence but sufficient relevance and marks them as candidate low-prominence entities. The server then outputs updated analysis information that additionally contains one or more low-prominence entities and viewpoint information indicating possible narrative perspectives centered on these entities.

### Step 6:

The server constructs a prompt sentence for a generative AI model based on the updated analysis information, the final-part text data, and the user's preference parameters. The input of this step is the structured analysis information, the original final-part text, and parameters such as desired length and tone. The server executes string construction operations that map structured fields (subject information, relationship information, viewpoint information, summary information) into natural language phrases inserted into a template. The server concatenates these phrases, inserts the final-part text, and appends explicit instructions regarding style, length, and constraints. The server, for example, constructs a prompt sentence such as:
“Title: Novel A
Main characters: Alice, Bob
Relationships: Alice and Bob are close allies who trust each other.
Themes: friendship, sacrifice
Here is the final part of the finished story:
[final-part text]
Based on the above, continue the story as the next chapter in Japanese, keeping the same tone, maintaining the relationships, and targeting a medium length.”
The server outputs the completed prompt sentence and a set of generation conditions including maximum tokens, sampling parameters, and other control values.

### Step 7:

The server sends the prompt sentence and the generation conditions to an external generative AI model via the communication interface. The input of this step is the prompt sentence and the generation conditions. The server packages these as parameters in a network request, typically formatted in a structured data representation, and transmits the request to the external computing resource that executes the generative AI model. The external model processes the prompt sentence by running multiple layers of matrix multiplications, attention computations, and non-linear activations according to its neural network architecture, and returns generated-document text data as a continuation of the completed document. The server receives the response and outputs the generated-document text data as a string or token sequence in its memory.

### Step 8:

The server performs content-checking processing and formatting processing on the generated-document text data. The input of this step is the raw generated-document text data received from the generative AI model. The server executes rule-based scanning to detect prohibited patterns, length checks to ensure conformance with requested length, and optional classifier-based evaluation to identify incoherent or off-topic segments. The server may remove or replace segments that fail these checks, or request regeneration for specific portions. The server then formats the remaining text by inserting paragraph breaks, headings, and consistent spacing, using rules that depend on sentence boundaries and structural markers. The server outputs display-structured data that contains the cleaned and formatted text, layout attributes, and metadata such as chapter title and generation timestamp.

### Step 9:

The server obtains emotion-state information of the user from an emotion recognition function and updates control parameters for future generation. The input of this step is emotion-related feature data or emotion labels associated with the user, which may be received from the terminal or from a dedicated emotion-recognition module. The server computes or receives an emotion label or a vector indicating levels of emotions such as engagement, stress, or boredom. The server then updates internal mappings that link emotion states to narrative control parameters, such as intensity level, conflict frequency, or desired length. The server outputs revised generation conditions and, optionally, modified prompt templates that will be used in subsequent invocations of the generative AI model.

### Step 10:

The server transmits the display-structured data to the terminal for presentation to the user. The input of this step is the structured representation of the formatted and checked generated-document text data. The server encapsulates this data in a response message and sends it over the network. The terminal receives the response and parses the structured data. The terminal converts the layout information into user interface elements and renders the text on the display device according to font settings, line spacing, and pagination rules. The terminal outputs a visual presentation of the generated-document text data on the screen, along with user interface controls for scrolling, navigating sections, and issuing regeneration requests.

### Step 11:

The user reads the presented generated-document text data on the display device of the terminal and may provide further operation input. The input of this step is the displayed text and controls visible to the user. The user may, for example, scroll the text, select options to view an alternative perspective based on a low-prominence entity, or press a button to request regeneration with different tone or length parameters. The terminal converts these physical interactions into digital events and outputs new requests to the server that include updated preference parameters or viewpoint selections, thereby closing the loop for iterative, adaptive story generation based on the generative AI model and the prompt sentence.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented story generation techniques primarily focus on producing linear textual continuations in response to a static input narrative. Such techniques generally treat the story as a simple input-output transformation problem and are not designed to manage a continuous, closed-loop interaction between a user's real-time state, a generative AI model, and a visualization platform. As a result, these techniques suffer from several technical limitations.

First, conventional systems typically do not parse generated narrative content into machine-usable structural units such as scenes, entities, locations, and actions, nor do they generate explicit mapping data that binds those structural units to visual resources. Because the generated text remains largely unstructured from the perspective of the rendering pipeline, the visualization process must rely on ad hoc, manual, or heuristic mappings, which increases processing overhead and reduces determinism and repeatability. This leads to inefficiencies in the data flow between the natural language generation stage and the rendering stage, such as redundant processing and non-optimal memory and bandwidth usage when delivering interactive visual content to user terminals.

Second, conventional systems generally treat user emotion and user input as optional, coarse-grained parameters, if they are considered at all. They typically lack a technical framework in which emotion information is captured as time-varying signal data, normalized and stored as part of the system state, and then fed back into a generative AI model via programmatically generated prompt sentences. Without such a framework, it is difficult for the system to adapt the generation and structuring of subsequent content in real time based on subtle user state changes, and the story remains essentially static. This results in low responsiveness and a limited ability to maintain user engagement across extended interactive sessions.

Third, existing architectures for interactive story experiences often separate the narrative generation pipeline from the visual rendering pipeline, such that each pipeline maintains its own independent logic and state. Because the scene-structuring logic, asset mapping logic, and visualization logic are not formally integrated with the generative AI prompt generation, these architectures require complex and brittle glue code. This fragmentation can cause inconsistencies between the textual content and the visual content, introduce synchronization problems between user input and content update, and increase latency when regenerating or updating story segments in response to user actions.

In view of the foregoing, there is a need for a computer-implemented system and method that: (i) programmatically constructs prompt sentences for a generative AI model based on a parsed representation of completed content; (ii) transforms generated subsequent content into structured scene information and resource mapping information suitable for efficient consumption by a visualization processing platform; and (iii) acquires and models user emotion information and user selection operations as time-varying state data that dynamically drive regeneration and updating of subsequent content. Such a system should improve the internal data structures and processing pipeline of the computer system itself, enabling reduced processing redundancy, more deterministic asset binding, tighter integration between generation and visualization, and responsive, adaptive control of interactive visual story experiences.

The specific processing by the specific processing unit 290 of the data processing device 12 in Application Example 1 is realized by the following means.

The present invention provides a server comprising a processor configured to parse text information of completed content; to generate a prompt sentence for instructing a generative AI model to generate subsequent text information of the content based on a result of the parsing; to input the prompt sentence and the text information of the completed content to the generative AI model and generate, by using the generative AI model, the subsequent text information; to divide the subsequent text information into a plurality of scene units and, for each scene unit, to extract appearance entities, position information, object information, and action information and structure the extracted information as scene structure information; to generate resource mapping information by associating, based on the scene structure information, each appearance entity and the position information with virtual display resources and to generate configuration information for visual representation based on the resource mapping information; to generate visual content corresponding to the subsequent text information by using a visualization processing platform based on the configuration information for visual representation and to cause a user terminal to present the visual content; to acquire selection operations or motion information from a user and to recognize an emotional state of the user as emotion information that changes over time; and to generate an additional prompt sentence for dynamically adjusting development of the subsequent text information based on the emotion information and the selection operations and to sequentially update the subsequent text information by inputting the additional prompt sentence to the generative AI model again. This enables the computer system to implement an integrated, closed-loop story generation and visualization pipeline in which narrative content is automatically structured into scene-level data and bound to visual resources, while user emotion information and user interactions are reflected in real time through regenerated prompt sentences and updated story segments, thereby improving internal data handling efficiency, synchronization between generated text and rendered visuals, and responsiveness of interactive content delivery.

The term “completed content” refers to information content, such as a finished narrative or story, that has reached an endpoint in its original form and whose text information is used as a basis for generating subsequent text information.

The term “text information” refers to information expressed as character data, including sentences, paragraphs, or other linguistic units, that can be processed by a computer system in order to perform parsing, analysis, and generation operations.

The term “prompt sentence” refers to a text instruction, including one or more sentences, that is generated by the processor and provided as input to a generative AI model in order to control or guide generation of subsequent text information.

The term “generative AI model” refers to an information processing model implemented by a computer, configured to generate new text information based on input text information, the prompt sentence, and internal parameters learned from training data.

The term “subsequent text information” refers to text information that is generated by the generative AI model as content following or continuing from the completed content.

The term “scene unit” refers to a division of subsequent text information into a smaller structural segment representing a coherent situation or event, including associated entities, locations, and actions.

The term “appearance entity” refers to an entity that appears in the text information, including a character, item, organization, or other identifiable subject referred to in the narrative.

The term “position information” refers to information indicating a spatial or environmental location associated with a scene unit or an appearance entity, such as a place, area, or setting described in the text information.

The term “object information” refers to information indicating a physical or conceptual object that appears in the text information and is associated with a scene unit, including items, props, or other tangible or intangible objects.

The term “action information” refers to information indicating an activity, behavior, or event performed by an appearance entity or occurring in a scene unit, as derived from verbs or action expressions in the text information.

The term “scene structure information” refers to structured data representing a scene unit, including appearance entities, position information, object information, and action information, organized in a format suitable for machine processing.

The term “virtual display resource” refers to a digital resource used for visual representation, including graphical models, images, animations, sounds, or other media elements that can be rendered by a visualization processing platform.

The term “resource mapping information” refers to information that associates elements of the scene structure information, such as appearance entities and position information, with corresponding virtual display resources to enable visual representation.

The term “configuration information for visual representation” refers to information used by a visualization processing platform to construct and render visual content, including references to virtual display resources, layout data, timing data, and presentation parameters.

The term “visualization processing platform” refers to a hardware and software environment configured to interpret configuration information for visual representation and to generate visual content, such as an engine for rendering two-dimensional or three-dimensional scenes.

The term “visual content” refers to output content presented in a visual form, including images, animations, or interactive scenes generated based on configuration information for visual representation.

The term “user terminal” refers to an information processing device operated by a user, such as a mobile device, head-mounted display, personal computer, or game console, capable of receiving and presenting visual content.

The term “selection operation” refers to an input operation performed by a user, including selection of options, commands, or actions through an input interface such as a touch screen, controller, or pointing device.

The term “motion information” refers to information representing physical motion of a user or an input device, including movement, orientation, or gestures detected by sensors or controllers.

The term “emotional state” refers to a state of a user's emotion, such as excitement, boredom, happiness, fear, or other affective conditions, as recognized by the system from input data.

The term “emotion information” refers to data representing the emotional state of the user, captured and modeled as time-varying information that can be used to control generation or adjustment of subsequent text information.

The term “additional prompt sentence” refers to a prompt sentence that is generated after initial generation of subsequent text information, based on emotion information and selection operations, and used to cause the generative AI model to update or further extend the subsequent text information.

The term “development of the subsequent text information” refers to progression, branching, or modification of narrative content within the subsequent text information, including changes in events, scenes, or character actions over time.

In one embodiment, a server, a plurality of terminals, and one or more storage devices cooperate to implement the claimed system. The server comprises at least one processor, a main memory, and a network interface. The terminals comprise information processing devices such as a mobile communication device, a head-mounted display device, or a general-purpose computer, each including a graphics processing unit, a display, and one or more input interfaces. The storage devices comprise a non-transitory computer-readable medium storing program instructions, model parameters, and content data.

The server executes an operating system such as a generic server operating system and a server application including a generative AI model runtime, a natural language processing module, a scene structuring module, a resource mapping module, a visualization configuration module, and a user state management module. The generative AI model is, in one embodiment, a transformer-based neural network including a plurality of self-attention layers, feed-forward layers, and layer normalization units. The server stores learned model parameters for the generative AI model, including weight matrices for attention heads, bias vectors, and embedding matrices for tokens.

The server stores text information of completed content in a content database. The server also stores virtual display resources, such as three-dimensional model files, two-dimensional texture files, animation files, and audio files, in an asset repository. Each virtual display resource is associated with one or more abstract identifiers, such as character type, environment type, or action category, in an asset metadata store. The server further stores mappings between appearance entities and abstract asset identifiers in a mapping table.

The server parses text information of completed content by using a natural language processing library executing on the processor. The server applies tokenization, sentence segmentation, part-of-speech tagging, and named-entity recognition. In one example, the server uses a generic statistical or neural network-based parser to identify sentence boundaries, grammatical structures, and named entities. The server extracts appearance entities, such as character names and organizations, and position information, such as place names or described locations, from the completed content. The server also detects temporal markers and event boundaries to determine points suitable for continuation by a generative AI model.

The server generates a prompt sentence based on the parsed result. The server concatenates or otherwise combines the extracted information with an instruction string so that the generative AI model receives both the completed content and a control directive. In one example, the server generates the following prompt sentence:
“Using a generative AI model, please read the following final chapter and generate a sequel to this story.”

In another example, the server generates the following prompt sentence:
“Using a generative AI model, please generate the next two scenes of the sequel in English, keeping the same style and characters as described in the following completed content.”

The server encodes the completed content and the prompt sentence using a tokenizer associated with the generative AI model. In the transformer-based model, the server converts each token into a vector using a learned embedding matrix. The server then applies a sequence of attention layers. In each attention layer, the server calculates query, key, and value vectors for each token using learned weight matrices, and the server calculates attention scores by computing dot products of queries and keys, followed by a softmax normalization.

The server multiplies the attention scores by the value vectors, sums the resulting vectors, and passes the result through a feed-forward network. The server repeats this process for multiple layers to compute representations for all tokens.

The server generates subsequent text information by using an autoregressive decoding procedure. The server calculates, for each output step, a probability distribution over the vocabulary based on the final layer representations and selects the next token according to a sampling scheme such as greedy decoding, top-k sampling, or nucleus sampling. The server sets parameters such as temperature and top-p to control randomness. The server repeats token generation until an end condition is met, such as generating a special end-of-sequence token or reaching a predetermined token limit. The server converts the generated token sequence back into subsequent text information in character form.

The server divides the subsequent text information into a plurality of scene units by analyzing changes in time, location, or main participants. The server applies a rule-based or statistical segmentation algorithm. In one example, the server assigns a new scene unit whenever a new paragraph begins with a temporal adverbial phrase or a location phrase, or whenever an identified set of appearance entities changes significantly. For each scene unit, the server extracts appearance entities, position information, object information, and action information by using the same or a similar natural language processing library as used for the completed content. The server represents these elements in a structured data format, for example as an internal record or object containing fields for entities, locations, objects, and actions. The server collectively refers to such structured data as scene structure information.

The server generates resource mapping information by associating elements of the scene structure information with virtual display resources. The server compares the extracted appearance entities and position information against an asset metadata store using normalized names, type classifications, and tags. For example, the server may map an appearance entity classified as “warrior” to a character model of type “warrior,” and may map position information classified as “castle interior” to a set of environment assets tagged with “castle” and “interior.” The server consults a mapping table that defines priorities or fallback rules when multiple potential assets exist. By performing this explicit mapping, the server produces resource mapping information that can be directly consumed by a visualization processing platform without repeated or heuristic asset search.

The server generates configuration information for visual representation based on the resource mapping information. The server assigns camera parameters, such as camera position, orientation, and field of view, for each scene unit. The server also defines animation sequences associated with action information, such as walking, speaking, or fighting. The server calculates scene timelines by assigning start times and durations for each action and dialogue line. The server encodes this configuration information in structured data, referencing specific asset identifiers and timing parameters. In one embodiment, the server formats the configuration information in a data structure that can be directly loaded by a game engine runtime on the terminal, thereby reducing conversion overhead at the terminal side.

The server generates visual content corresponding to the subsequent text information by using a visualization processing platform. In one embodiment, the server generates a set of scene configuration files and delivers them to the terminal, and the terminal executes a game engine to instantiate and render corresponding scenes. The terminal loads the configuration information, instantiates three-dimensional objects or two-dimensional sprites corresponding to the virtual display resources, sets their positions and orientations in a scene graph, and plays animations according to the defined timelines. In another embodiment, the server executes a rendering engine on a server-side graphics processor to produce compressed video or streaming content, and the terminal decodes and displays the content. In both embodiments, the terminal displays the visual content on a display screen or on a head-mounted display, and the terminal outputs associated audio via speakers or headphones.

The user interacts with the visual content by operating an input device. The terminal acquires selection operations, such as selecting one of multiple options displayed on the screen, or motion information, such as head movement or controller movement detected by inertial sensors. The terminal transmits the input data to the server. The server recognizes an emotional state of the user as emotion information that changes over time. The server may use physiological signals, behavioral signals, or interaction patterns, such as frequency of option changes, time taken to respond, or gaze direction, as features. In one embodiment, the server applies a separate neural network model, such as a recurrent neural network or a temporal convolutional network, to classify emotional states (for example, excitement, boredom, or confusion) based on a time series of such features. The server stores the emotion information as a time-varying vector in a user state database.

The server generates an additional prompt sentence for dynamically adjusting development of the subsequent text information based on the emotion information and the selection operations. The server incorporates summaries of the user's recent emotional trajectory and explicit choices into the additional prompt sentence. For instance, the server may generate the following additional prompt sentence:
“Using a generative AI model, continue the sequel from this point. The user has repeatedly chosen cautious options and appears anxious. Please generate the next scene with lower intensity and more reassurance.”

In another example, the server may generate the following additional prompt sentence:
“Using a generative AI model, please generate the next scene in which the protagonist follows the mysterious figure into the forest, with increased suspense, because the user has shown high engagement.”

The server again encodes the current context, the additional prompt sentence, and any necessary excerpt of the previous subsequent text information, and reuses the same transformer-based decoding procedure to generate updated or extended subsequent text information. By repeating this process, the server updates the scene structure information and resource mapping information incrementally, without reconstructing the entire story from the beginning.

The server improves computer technology in several respects. First, by converting free-form generated text into explicit scene structure information and resource mapping information, the server reduces the need for repeated parsing and ad hoc asset matching at the terminal. This structured representation allows the terminal to perform deterministic loading and rendering, reducing computational overhead and latency. Second, by integrating emotion information and selection operations into additional prompt sentences and linking them to the generative AI model's decoding process, the server creates a closed feedback loop that is not achievable by simple human editing. The system uses time-varying emotion vectors and explicit behavior logs as machine-interpretable control signals, enabling fine-grained adaptation of narrative generation. Third, because the server manages internal data structures for scenes, assets, and user state, the system reduces redundant network transmissions by sending only incremental configuration changes when scenes are updated, thereby reducing communication load.

The server uses a training procedure for the generative AI model that includes pre-training and fine-tuning. In pre-training, the server executes a training program on a training dataset of text information. The server minimizes a cross-entropy loss between predicted and actual next tokens using gradient-based optimization, such as stochastic gradient descent with adaptive learning rate. The server updates weight matrices and bias vectors in the transformer layers by computing gradients via backpropagation through time. In fine-tuning, the server uses a dataset that includes narrative content labeled with scene boundaries, entity types, and emotional annotations. The server introduces auxiliary loss terms to encourage the model to maintain consistency of entities and locations across generated segments. As a result, the generative AI model produces subsequent text information that is more amenable to scene structuring and resource mapping.

The server also applies data augmentation to improve robustness. For example, the server may reorder certain non-critical clauses, inject paraphrases, or mask parts of the input text information during fine-tuning. These operations encourage the model to focus on narrative structure rather than exact wording. The server may store different sets of model parameters for different content genres, such as fantasy, mystery, or romance, and select an appropriate parameter set based on the completed content.

The terminal executes a game engine application that is configured to interpret the configuration information for visual representation received from the server. The terminal may execute a lightweight runtime that includes only generic rendering and physics modules. Because the server has already bound abstract narrative elements to specific assets and defined timelines, the terminal can instantiate scenes without performing heavy natural language processing or complex AI inference. This division of labor improves processing efficiency on resource-constrained terminals, such as mobile devices and head-mounted displays, and allows smooth rendering at higher frame rates.

The server can implement alternative embodiments. In one alternative, the server generates scene structure information using a hybrid approach that combines rule-based detection with a neural sequence tagger. In another alternative, the server uses a different type of generative AI model, such as a sequence-to-sequence recurrent network with attention, instead of a transformer model. In yet another alternative, the server allows the terminal to perform a subset of the parsing operations locally, for example, to segment dialogue lines for display, while the server performs the more complex entity extraction and mapping tasks.

The server and the terminal may also support different user interface modes. In one mode, the terminal presents textual subtitles accompanying the visual content, while in another mode, the terminal converts dialogue lines into synthesized speech by using a speech synthesis engine. The server can adjust the configuration information for visual representation to include timing data for lip synchronization and camera cuts matched to synthesized speech durations.

By tightly integrating the generative AI model, the scene structuring logic, the resource mapping logic, and the visualization pipeline, the server realizes a technical improvement in how computers generate, structure, and render narrative content. The server reduces the number of conversions between unstructured and structured forms by maintaining an internal representation that directly feeds into a rendering engine. The server thereby achieves faster responsiveness to user actions, improved consistency between generated text and rendered visuals, and reduced communication and computation loads, which constitutes an improvement in computer technology beyond mere automation of human storytelling.

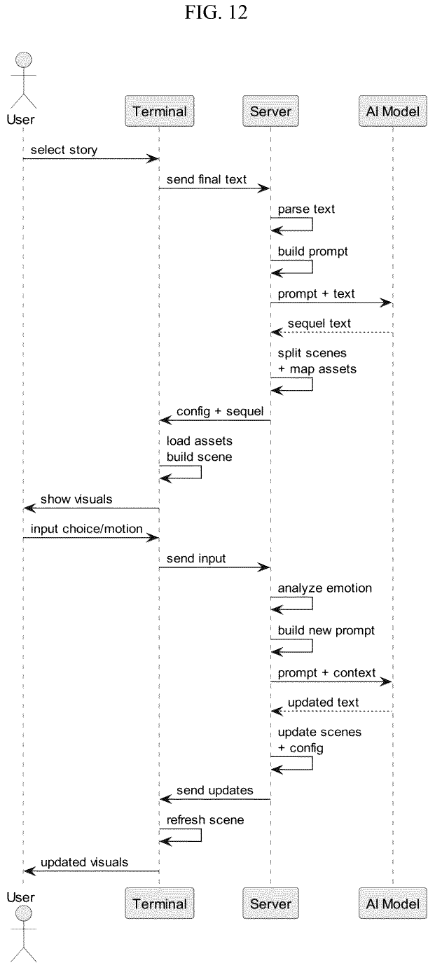

The following describes the processing flow using FIG. 12.

### Step 1:

The user operates the terminal to select a completed content item from a list displayed on a screen. The terminal reads text information of the completed content, at least including a final portion, from local storage or from a remote content source. As input, the terminal uses a content identifier selected by the user, and as output, the terminal obtains the corresponding text information. The terminal then transmits the text information and the content identifier to the server over a network.

### Step 2:

The server receives the text information of the completed content from the terminal. As input, the server uses the received text information and the content identifier. The server stores the text information in a temporary buffer in memory and logs metadata, such as a user identifier and a timestamp, in a database. As output, the server produces a normalized internal representation of the received text information suitable for subsequent parsing.

### Step 3:

The server parses the text information of the completed content. As input, the server uses the normalized text information. The server performs tokenization, sentence segmentation, part-of-speech tagging, and named-entity recognition using a natural language processing library. The server thereby extracts appearance entities, position information, object references, and action verbs. As output, the server generates parsed data structures that annotate the text with entity tags, location tags, and syntactic roles.

### Step 4:

The server generates a prompt sentence based on the parsed data. As input, the server uses the parsed data structures and the original text information. The server composes an instruction string that specifies how a generative AI model should generate subsequent text information. For example, the server may generate a prompt sentence such as “Using a generative AI model, please read the following final chapter and generate a sequel to this story.” The server concatenates the instruction string with the completed content as a prompt sequence. As output, the server produces a combined prompt sequence to control the generative AI model.

### Step 5:

The server encodes the combined prompt sequence for input to the generative AI model. As input, the server uses the combined prompt sequence. The server applies a tokenizer associated with the generative AI model to convert characters or words into token identifiers. The server then maps each token identifier to a vector using an embedding matrix stored in memory. As output, the server obtains a sequence of embedded vectors representing the prompt sequence.

### Step 6:

The server generates subsequent text information by using the generative AI model. As input, the server uses the sequence of embedded vectors. The server applies multiple layers of a transformer-based neural network, including self-attention layers and feed-forward layers, to compute contextualized representations. The server then computes, for each decoding step, a probability distribution over vocabulary tokens and selects a next token according to a decoding strategy using parameters such as temperature and top-p. The server repeats this process until an end condition is satisfied. As output, the server obtains a generated sequence of tokens and converts the tokens into human-readable subsequent text information.

### Step 7:

The server segments the subsequent text information into scene units. As input, the server uses the subsequent text information. The server detects scene boundaries by applying rule-based patterns and statistical criteria, such as changes of time expressions, location descriptions, or sets of active appearance entities. The server assigns consecutive text segments to respective scene units. As output, the server produces a list of scene units, each associated with a corresponding text segment.

### Step 8:

The server extracts structured information for each scene unit. As input, the server uses the text segment of each scene unit. The server applies natural language processing to identify appearance entities, position information, object information, and action information contained in each scene unit. The server constructs, for each scene unit, a record including fields for entities, locations, objects, and actions. As output, the server generates scene structure information for all scene units.

### Step 9:

The server generates resource mapping information from the scene structure information. As input, the server uses the scene structure information and an asset metadata store that describes virtual display resources. The server matches appearance entities and position information to corresponding virtual display resources by comparing labels, types, and tags. The server may apply priority rules and fallback rules when multiple candidates exist. As output, the server produces resource mapping information that specifies, for each entity and location, identifiers of associated virtual display resources.

### Step 10:

The server generates configuration information for visual representation. As input, the server uses the scene structure information and the resource mapping information. The server defines layout parameters, such as positions and orientations of entities within a scene, and timing parameters, such as start times and durations for actions and dialogue. The server assigns camera parameters and lighting presets based on scene types and action types. As output, the server creates configuration information for visual representation in a structured format that references virtual display resources and includes timing and layout data.

### Step 11:

The server transmits the configuration information and relevant text information to the terminal. As input, the server uses the configuration information, the subsequent text information, and a session identifier. The server packages these into a response message and sends the response to the terminal via a communication interface. As output, the server delivers data enabling the terminal to construct and render visual content corresponding to the subsequent text information.

### Step 12:

The terminal receives the configuration information and the subsequent text information. As input, the terminal uses the response message from the server. The terminal parses the configuration information and stores it in local memory. The terminal then loads the specified virtual display resources from local storage or via network retrieval if necessary. As output, the terminal prepares instantiated asset objects and internal scene configuration ready for rendering.

### Step 13:

The terminal constructs scenes based on the configuration information. As input, the terminal uses the configuration information and the loaded virtual display resources. The terminal instantiates visual objects, positions entities in a virtual space, applies animations corresponding to action information, and configures cameras and lights as specified. The terminal binds the subsequent text information to user interface elements, such as subtitles or dialogue windows. As output, the terminal generates a renderable scene graph and associated UI elements.

### Step 14:

The terminal renders and presents visual content to the user. As input, the terminal uses the renderable scene graph and UI elements. The terminal executes a rendering loop on a graphics processing unit to draw frames according to the scene graph and to update animations over time. The terminal displays the frames on a screen or a head-mounted display and plays associated audio. As output, the terminal presents an interactive visual experience corresponding to the subsequent text information.

### Step 15:

The user interacts with the visual content via input devices. As input, the user perceives the displayed scenes and available options. The user performs selection operations, such as choosing a narrative option, or generates motion information, such as moving a controller or changing head orientation. As output, the user provides input signals that the terminal can capture.

### Step 16:

The terminal captures user input and transmits it to the server. As input, the terminal uses raw signals from input devices, such as button presses, touch coordinates, or sensor readings. The terminal interprets the raw signals as selection operations or motion information and assigns time stamps. The terminal then sends these interpreted inputs, together with a current scene identifier and session identifier, to the server. As output, the terminal generates formatted input data for user state analysis.

### Step 17:

The server analyzes the user input to recognize an emotional state. As input, the server uses the selection operations, the motion information, and optionally historical interaction data. The server computes features such as response times, frequency of option changes, movement magnitude, and dwell times. The server applies an emotion recognition model, such as a neural network trained on time-series data, to classify or estimate the user's emotional state. As output, the server produces emotion information represented as a time-varying vector or label set.

### Step 18:

The server generates an additional prompt sentence for dynamic adjustment. As input, the server uses the emotion information, the recorded selection operations, and the current subsequent text information. The server summarizes the user's recent preferences and emotional trend and embeds this summary into a control instruction for the generative AI model. For example, the server may generate a prompt sentence such as “Using a generative AI model, continue the sequel from this point. The user appears highly engaged and prefers adventurous choices. Please generate the next scene with increased suspense.” As output, the server creates an additional prompt sentence suitable for modifying or extending the narrative.

### Step 19:

The server updates the subsequent text information using the additional prompt sentence. As input, the server uses the additional prompt sentence and a context portion of the existing subsequent text information. The server encodes these inputs into tokens and embedded vectors and processes them through the generative AI model, using the same neural network layers as in initial generation. The server generates new tokens that either replace part of the previous continuation, add new scenes, or branch the story according to the emotion information and user choices. As output, the server obtains updated subsequent text information that reflects the dynamic adjustment.

### Step 20:

The server regenerates or updates scene structure information and configuration information. As input, the server uses the updated subsequent text information and the previously stored scene structure information and resource mapping information. The server determines which scene units are newly generated or modified and re-applies segmentation and information extraction only to those portions. The server updates the scene structure information and recalculates resource mapping information and configuration information for the affected scenes. As output, the server produces incremental changes to the configuration information for visual representation.

### Step 21:

The server transmits incremental updates to the terminal. As input, the server uses the incremental configuration changes and identifiers of affected scenes. The server constructs an update message that includes only the modified scene data and any new asset references. The server sends this update message to the terminal. As output, the server reduces communication load by avoiding retransmission of unchanged configuration information.

### Step 22:

The terminal applies the incremental updates and refreshes the visual content. As input, the terminal uses the update message from the server. The terminal updates its internal scene graph by modifying or replacing only the specified scene units and associated assets. The terminal adjusts camera paths, animations, and dialogue text according to the updated configuration. As output, the terminal presents a modified visual experience that adapts to the user's emotional state and interaction history without reconstructing the entire scene from scratch.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional content generation systems using generative AI models are typically driven by static prompts manually crafted by human operators. Such systems mainly extend or imitate narrative content without deeply analyzing the underlying structure of a completed narrative, including narrative entities, their relative prominence, and their contextual roles. As a result, known systems lack a systematic mechanism to automatically identify non-main entities in an existing narrative and to generate new narratives from alternative viewpoints while preserving narrative consistency with the original work. This limits the diversity and granularity of narrative perspectives that can be generated from completed works and reduces the utility of generative AI models as tools for narrative exploration and transformation. Furthermore, many existing systems treat user interaction as a one-time input at the beginning of generation, and do not incorporate real-time user state, such as user emotion, into the core generative loop. In such systems, once a narrative generation process starts, the generative AI model proceeds according to a fixed prompt and fixed parameters, regardless of how the user's emotional state evolves while consuming the content. As a consequence, these systems cannot dynamically adapt narrative development (e.g., pacing, intensity, emotional tone, character focus) in response to user feedback or user affective responses. This leads to suboptimal user engagement and fails to leverage the potential of adaptive narrative computing.

From the perspective of computer technology, existing approaches underutilize natural language processing pipelines and model orchestration mechanisms in their integration with generative AI models. They lack: (i) an automated pipeline for transforming raw narrative text of a completed work into structured analysis data including main and non-main entities, (ii) a systematic method for generating context-aware prompt sentences that instruct a generative AI model to produce a new narrative from a non-main entity's viewpoint while maintaining world settings and principal events, and (iii) a feedback loop in which real-time user emotion information is used to dynamically update prompt sentences, control parameters, and input data for the generative AI model during ongoing narrative generation. Thus, there is a need for an improved computer-implemented system that: automatically analyzes completed narrative text to identify main and non-main entities; constructs rich, context-based prompt sentences that cause a generative AI model to generate a new narrative from a non-main entity's viewpoint in a manner consistent with the original narrative; and uses real-time user emotion information to adjust narrative development during generation. Such a system would improve the functioning of computers in the specific technical context of narrative analysis and generative AI orchestration by providing an automated, iterative control mechanism between natural language processing modules, a generative AI model, and user state acquisition modules.

The specific processing by the specific processing unit 290 of the data processing device 12 in Example 2 is realized by the following means.

The present invention provides a server comprising a processor configured to acquire character-based information of a completed narrative from external information sources, perform preprocessing on the acquired character-based information, and store preprocessed information as analysis target data; execute natural language processing on the analysis target data, including at least morphological analysis, tokenization, part-of-speech tagging, and entity extraction, and identify a main narrative entity and a non-main narrative entity based on appearance frequency, appearance positions, and interrelationships among entities; generate summary information of the entire narrative and extract, from the analysis target data, context segments corresponding to scenes involving the non-main narrative entity so as to generate context information related to the non-main narrative entity; construct a context-rich prompt sentence based on the summary information and the context information, the prompt sentence instructing a generative AI model to generate a narrative from a different viewpoint while maintaining settings and principal events of the completed narrative and designating the non-main narrative entity as a new protagonist; supply the constructed prompt sentence as input data to the generative AI model and cause the generative AI model to generate new narrative information from the viewpoint of the non-main narrative entity; acquire user emotion information in real time from a user state acquisition apparatus and, based on the user emotion information, dynamically update at least one of additional prompt sentences, control parameters, and additional input data for the generative AI model so as to sequentially adjust narrative development in the generated narrative information; and convert the generated narrative information into display data and transmit the display data to a terminal for visual presentation to the user. This enables improved computer-based narrative generation in which a completed narrative is automatically analyzed to derive main and non-main entities, a generative AI model is programmatically guided by structured prompt sentences to generate a new narrative from a non-main entity's viewpoint while preserving narrative consistency, and real-time user emotion information is incorporated into a closed feedback loop that dynamically controls the generative AI model, thereby enhancing adaptability, responsiveness, and overall effectiveness of the narrative generation process as a computer-implemented technology.

The term “completed narrative” refers to narrative text data representing a story, such as a literary work or other sequence of narrative events, that has reached an ending as originally authored and is not intended to be further extended within the original work.

The term “character-based information” refers to digital text or text-derived data representing the content of a narrative, including characters, dialogue, narration, and descriptive passages, encoded in a form suitable for computer processing.

The term “external information sources” refers to network-accessible data providing systems, such as online databases, content distribution platforms, or storage services, from which narrative text or related data can be acquired via a communication network.

The term “analysis target data” refers to narrative-related data that has been preprocessed and stored in a form suitable for subsequent natural language processing, entity extraction, summarization, and context analysis.

The term “natural language processing” refers to computer-implemented processing of human language text, including at least tokenization, morphological analysis, part-of-speech tagging, syntactic analysis, and named entity recognition, performed to derive structured linguistic information from unstructured text.

The term “entity extraction” refers to a process of identifying and labeling occurrences of semantic units, such as persons, locations, organizations, and other narrative-relevant entities, in text using automatic or rule-based techniques.

The term “narrative entity” refers to an entity that appears in a narrative and participates in the story, including at least characters, groups, or other person-like agents that have roles within the narrative structure.

The term “main narrative entity” refers to a narrative entity that is determined, based on quantitative or qualitative analysis of a completed narrative, to be a principal focus of the narrative, for example due to high appearance frequency, early introduction, or central involvement in key events.

The term “non-main narrative entity” refers to a narrative entity that appears in a completed narrative but is not identified as the main narrative entity, and that is treated as a secondary or supporting entity in the original narrative.

The term “appearance frequency” refers to a numerical or statistical measure of how often a given narrative entity or term appears within the narrative text, computed over a defined textual scope.

The term “appearance position” refers to information indicating where in the narrative text a particular entity occurs, including indices, chapter positions, scene identifiers, or other structural locations.

The term “interrelationships among entities” refers to relationships determined between narrative entities based on co-occurrence patterns, syntactic relations, dialogue interactions, or other narrative cues extracted from the text.

The term “summary information” refers to condensed data that captures essential aspects of a completed narrative, including at least main characters, principal events, and core plot elements, in a shorter form than the original narrative text.

The term “context segments” refers to portions of narrative text, such as sentences, paragraphs, scenes, or chapters, that are extracted because they contain or are proximate to references to a particular narrative entity.

The term “context information” refers to structured or semi-structured information derived from context segments, describing circumstances, events, relationships, and narrative roles associated with a particular narrative entity.

The term “prompt sentence” refers to one or more machine-readable text instructions provided as input to a generative AI model, the instructions specifying constraints, style, perspective, or content requirements for narrative generation.

The term “generative AI model” refers to a machine learning model configured to generate natural language text based on input data, such as prompt sentences and control parameters, for example a neural network language model.

The term “viewpoint” refers to a narrative perspective from which events are described, including at least the identity of the entity whose internal thoughts, observations, and experiences are primarily expressed in the generated narrative.

The term “settings” refers to the environmental and situational aspects of a narrative world, including time periods, locations, social structures, and rules that define the narrative universe.

The term “principal events” refers to key plot points, major incidents, or core narrative developments that substantially define the structure and outcome of a completed narrative.

The term “new narrative information” refers to computer-generated narrative text output by a generative AI model based on one or more prompt sentences and other input data.

The term “user state acquisition apparatus” refers to a hardware and/or software component configured to acquire information indicative of a user's state, such as emotional state, through sensors, user input, or external services.

The term “user emotion information” refers to data representing an estimated or detected emotional state of a user, including at least an emotion type, emotion label, or emotion intensity.

The term “emotion label” refers to a categorical representation of a user's emotional state, such as joy, sadness, fear, anger, surprise, or other affective categories.

The term “emotion intensity” refers to a quantitative measure indicating a strength or degree of a particular emotional state associated with a user.

The term “additional prompt sentences” refers to one or more prompt sentences generated after an initial prompt sentence, the additional prompt sentences being used to influence continuation, revision, or redirection of text generation by a generative AI model.

The term “control parameters” refers to numerical or symbolic configuration values supplied to a generative AI model, such as temperature, maximum token count, randomness settings, or other parameters that affect output style and variability.

The term “additional input data” refers to data, other than a main prompt sentence, supplied to a generative AI model, including previous context, partial outputs, summaries, or constraints, used to control or guide further generation.

The term “narrative development” refers to the progression of plot, events, emotional tone, and character actions in a narrative as it unfolds over time.

The term “display data” refers to formatted data derived from narrative text and associated metadata that is suitable for rendering by a display apparatus on a terminal.

The term “terminal” refers to a user-operated computing device, such as a mobile device, tablet, personal computer, or similar apparatus, configured to receive display data and present content to a user.

The term “screen display information” refers to data that defines how narrative content and related elements are visually arranged and rendered on a display of a terminal.

The term “chapter unit” refers to a division of narrative content corresponding to a chapter or other large structural section of a story.

The term “scene unit” refers to a division of narrative content corresponding to a scene or localized segment of narrative action within a story.

The term “paragraph unit” refers to a division of narrative content corresponding to a paragraph or similar contiguous block of text within a story.

The term “updated narrative character information” refers to narrative text data that has been revised or supplemented in response to newly applied conditions, such as user emotion information, and that replaces or extends previously generated narrative text.

In one embodiment, a server implements the claimed system by executing a set of software modules on general-purpose computing hardware. The server uses, for example, a multi-core central processing unit (CPU), volatile and non-volatile memory, a network interface controller, and a storage device. The server runs an operating system such as a UNIX-compatible operating system and executes application software including a scripting language runtime (for example, a Python interpreter), a natural language processing library (for example, a library implementing tokenization, part-of-speech tagging, and named entity recognition such as spaCy or a similar framework), an HTTP client library (for example, a library implementing HTTPS communication), and a generative AI model interface library configured to communicate with a remotely hosted generative AI model. The server stores narrative text data, analysis results, and generated narrative data in a structured storage subsystem such as a relational database management system or a key-value store.

The server acquires character-based information of completed narratives from external information sources. The server communicates with external content storage systems through an application programming interface (API) using HTTPS over a communication network.

The server transmits a request that includes an identifier of a target narrative and receives a structured response containing narrative text encoded, for example, in a markup format or a structured data format. The server parses the response and extracts raw narrative text, including at least dialogue portions, narration, and descriptive passages. The server stores the extracted narrative text as raw narrative records in storage.

The server performs preprocessing on the raw narrative records to generate analysis target data. The server executes, in software, normalization operations including unification of character encodings, normalization of whitespace, removal of markup tags, and segmentation of the narrative into structural units such as chapters, scenes, and paragraphs. The server represents the narrative as a data structure comprising an ordered list of paragraphs, each paragraph containing a string field and associated indices indicating its position within the narrative. The server stores the resulting data structure in memory and in persistent storage as analysis target data.

The server executes natural language processing on the analysis target data. The server calls a natural language processing engine that implements a pipeline of operations including tokenization, morphological analysis, part-of-speech tagging, dependency parsing, and named entity recognition. The natural language processing engine may be configured with a statistical or neural model trained on language data to assign part-of-speech tags to tokens and to extract person entities from text. The server receives, for each paragraph, a list of token objects, where each token object includes at least a textual form, a lemma, a part-of-speech tag, and dependency information. The server also receives, for each paragraph, a list of entity objects, where each entity object includes a category (for example, person) and a span indicating token indices.

The server identifies narrative entities from the entity objects by aggregating entity mentions that refer to the same underlying character or actor in the narrative. The server performs normalization of names by applying rules that match different surface forms (for example, given name only, family name only, honorifics) to a canonical entity identifier. The server stores, in an entity table, for each narrative entity, attributes including a canonical name, a list of mention positions, and counts of mentions. The server computes, for each entity, an appearance frequency equal to the number of mentions, and an appearance position distribution indicating the distribution of mentions over chapters or scenes. The server also computes interrelationships among entities by counting co-occurrence within a defined window of text, such as a paragraph or a pair of adjacent paragraphs, and by considering syntactic roles derived from dependency parsing. The server represents these interrelationships, for example, as a weighted graph stored in memory.

The server determines a main narrative entity and at least one non-main narrative entity based on the computed statistics. The server applies a scoring algorithm that combines appearance frequency, dispersion over the narrative, and centrality in the interrelationship graph. In one example, the server computes, for each entity, a score S as a weighted sum of normalized mention frequency, normalized number of chapters in which the entity appears, and a centrality measure such as degree centrality or PageRank-like centrality in the entity co-occurrence graph. The server identifies the entity with the highest score as the main narrative entity. The server marks entities with substantially lower scores, or entities explicitly designated by configuration data, as non-main narrative entities. This quantitative selection procedure allows the server to perform consistent and repeatable identification of main and non-main entities at scale and with improved accuracy compared to manual heuristics.

The server generates summary information of the entire narrative by compressing the analysis target data while retaining essential plot information. The server can implement a rule-based summarization method, a neural sequence-to-sequence model, or a combination thereof. For example, the server may call a generative AI model configured for summarization, providing the narrative text in segments and receiving a summary that identifies key events and principal entities. Alternatively or additionally, the server may select salient sentences based on scoring functions that consider entity density, position within the narrative, and presence of cue phrases. The server stores the resulting summary text as summary information, which serves as condensed input for subsequent prompt construction, thereby reducing bandwidth and computation costs when interacting with the generative AI model.

The server extracts context segments corresponding to scenes involving a selected non-main narrative entity. The server traverses the analysis target data and selects paragraphs that contain mentions of the selected non-main entity. The server expands selection to include neighboring paragraphs within a configurable window to capture sufficient narrative context around each mention. The server aggregates these paragraphs into context segments and annotates each segment with metadata including segment boundaries and involved entities.

The server thus generates context information describing where, when, and with whom the non-main entity appears in the original narrative.

The server constructs a prompt sentence for a generative AI model based on the summary information and the context information. The server assembles a text instruction that includes, in a structured manner, a section containing the summary, a section containing excerpts of context segments involving the non-main entity, and a section containing explicit instructions regarding narrative viewpoint, style, and constraints. For example, the server generates a prompt sentence such as:
“You are a novelist. Below is a summary of the finished comic “B” and an excerpt about the supporting character “C”.
[Summary of the work]
[Insert summary here]
[Excerpt about character C]
[Insert excerpt of a scene in which C appears here]
Instructions:
1. create a story in Japanese in which “C” is the new protagonist. 2. Do not change the worldview and major events of the original story significantly, but focus on how “C” experienced the events, what he felt, and how he grew up. 3. 3. tell the story from “C's” point of view in the first person (e.g., “I,” “me,” etc.). 4. 4. please keep the length of your essay to approximately 3,000 words.”

Alternatively, the server generates a prompt sentence in another language, such as:
“You are a novelist. Below is a summary of the finished manga ‘B’ and some key scenes involving the side character ‘C’. Using this information, write a new story from C's first-person point of view. Keep the main plotline consistent with the original, but focus on C's hidden motives, feelings, and actions that were not fully revealed before. Length: about 3000 words.”

The server may further embed conditions based on configuration data, such as desired tone or age rating, by appending additional instructions to the prompt sentence. The server thus produces a machine-readable prompt sentence that explicitly guides the generative AI model to maintain consistency with the original narrative while shifting viewpoint to the non-main entity.

The server supplies the constructed prompt sentence to a generative AI model. In one embodiment, the generative AI model is a neural network language model with a transformer architecture comprising a plurality of self-attention layers, feedforward layers, and layer normalization, trained on large corpora of text by minimizing a cross-entropy loss between predicted token distributions and actual next-token labels. During training, the model updates weight parameters using gradient-based optimization such as stochastic gradient descent or an adaptive variant, and may employ data augmentation techniques such as masking or shuffling to improve generalization. The server interacts with the model through an API that receives the prompt sentence as input and returns generated narrative text token-by-token or segment-by-segment.

The server configures generation parameters such as maximum token length, temperature, top-k or top-p sampling thresholds, and repetition penalties. By setting these parameters, the server controls trade-offs between creativity and determinism in the generated narrative. The server receives the model's output as a sequence of tokens, decodes the tokens into a character sequence according to the model's vocabulary encoding, and aggregates the decoded text as new narrative information from the viewpoint of the non-main entity. The server may perform additional validation on the generated text, such as checking for encoding errors, ensuring the presence of required structural markers, or verifying approximate length.

The server integrates user emotion information to dynamically adjust narrative development. A user state acquisition apparatus, such as a camera and microphone attached to the terminal or peripheral sensors, acquires raw data indicating the user's facial expressions, voice tone, physiological signals, or explicit feedback. Software on the terminal or on the server processes these signals using emotion detection algorithms, which may themselves be implemented as classifiers trained on labeled emotional data using supervised learning and loss functions such as cross-entropy. The server receives user emotion information in the form of an emotion label and, optionally, an emotion intensity value updated at regular intervals while the user consumes the generated narrative.

The server maintains an internal narrative state model representing, for example, the current chapter, scene, and emotional valence of the narrative. When the server receives updated emotion information, the server evaluates whether the user's emotional state diverges from a target range defined for the current narrative section. If the user's emotion indicates boredom or low engagement, the server modifies subsequent prompt sentences by specifying higher pacing, increased conflict, or introduction of surprising events. If the user's emotion indicates excessive stress or negative affect, the server adjusts style conditions in the prompt sentence to reduce intensity, increase supportive interactions, or emphasize resolution. The server may generate an additional prompt sentence that refers to the last generated segment and requests a continuation or revision with modified narrative development conditions. In this way, the server updates control parameters and prompt content based on signals that are not trivially available to a human author in real time, thereby enabling an adaptive feedback loop.

The server then requests the generative AI model to generate additional narrative segments under the updated conditions. The server aligns the newly generated segment with previously generated segments by enforcing continuity constraints in the prompt sentence, such as reiterating key facts and instructing avoidance of contradictions. The server may use text alignment or semantic similarity measures to ensure coherence at segment boundaries. The server thereby produces updated narrative information that is customized to the evolving user emotional state while maintaining internal consistency.

The server converts the generated narrative information into display data suitable for presentation on a terminal. The server structures the narrative into logically grouped sections and formats the text according to a presentation schema, which may include markup for headings, paragraphs, and dialogue. The server may add metadata such as titles, protagonist identifiers, and timestamps. The server transmits the display data to the terminal using a communication protocol such as HTTPS.

The terminal is a user-operated computing device such as a smartphone, tablet, or personal computer. The terminal executes a client application that receives the display data, parses the structured format, and renders the narrative text on a display device using a graphical user interface toolkit. The terminal may support interface functions such as scrolling, font size adjustment, and theme selection. The terminal may present controls that allow the user to select a completed narrative and a non-main entity via a list or search interface at the outset.

The terminal also presents the generated narrative segments in near real time as the server updates them in response to user emotion information.

The user interacts with the system by selecting a particular completed narrative and a character who was not the original protagonist and by reading the generated narrative on the terminal. The user may provide explicit feedback, such as rating segments or indicating preferences for more action or more introspection, which the terminal transmits to the server as additional user state data. The user may also permit the terminal to collect sensor data for automatic emotion detection. From the user's perspective, the system produces a coherent narrative from the new viewpoint with dynamically adjusted pacing and tone.

This configuration provides technical effects that go beyond mere automation of human storytelling. By executing structured natural language processing and entity analysis on completed narratives, the server reduces the computational search space that a generative AI model must explore to construct a consistent new narrative. The use of precomputed entity graphs and summary information enables shorter prompt sentences and reduced token usage, which in turn decreases network transmission volume and model inference time. The division of the narrative into paragraphs, chapters, and scenes, and the maintenance of an internal narrative state model, allow the server to reuse intermediate analysis results for multiple prompt sentences, thereby improving computational efficiency.

Furthermore, the integration of real-time user emotion information into the generation control loop causes the generative AI model to operate under dynamically modulated conditions that optimize user engagement. The server does not simply translate human instructions into text; instead, it computes quantitative adjustments to generation parameters and prompt constraints based on emotion labels and intensities, leveraging algorithmic rules and thresholds that cannot be applied consistently by human authors in real time. The causal relationship between emotion-based parameter adjustment and user engagement can be observed: by modifying narrative intensity when emotion intensity exceeds predetermined ranges, the server reduces the probability of user drop-off and improves sustained interaction with the terminal. This behavior is implemented through explicit algorithms operating on internal data structures, not through generic human-like judgment.

In addition, the generative AI model, as a transformer-based neural network, is trained using large-scale datasets and loss functions that ensure the model can generalize narrative structure and language patterns. However, the server constrains the model's operation through the constructed prompt sentences and control parameters so that the model performs a specialized task: generating narratives from non-main entity viewpoints consistent with a specific completed narrative and responsive to user emotion. This specialization is achieved without retraining the model, solely through orchestrated input and parameter control, demonstrating an improvement in how the computing system uses the model as a computational component.

Alternative embodiments are possible. The server may implement the generative AI model locally instead of via an external service, in which case the server stores model parameters and executes forward passes through the neural network using a numerical computation library and a graphics processing unit or tensor processing unit. The server may replace or complement the named entity recognition module with a rule-based coreference resolution module to improve accuracy of entity aggregation. The server may modify the scoring algorithm for main and non-main entities to weight specific narrative roles or dialog frequency. The server may utilize different summarization algorithms, such as extractive summarization based on unsupervised clustering of sentence embeddings, to generate summary information. The server may also employ different emotion detection mechanisms, such as keyboard interaction analysis or reading speed analysis, to derive user emotion information when sensors are not available.

In all such embodiments, the server maintains the core technical characteristics: programmatic identification of main and non-main narrative entities through structured natural language processing; construction of context-rich prompt sentences that configure a generative AI model to generate new narratives from the viewpoint of a selected non-main entity while preserving narrative consistency; and dynamic, real-time adjustment of narrative development based on algorithmic processing of user emotion information. By tightly integrating these components in software and hardware, the system improves the functioning of the computer in the specialized context of narrative generation, offering concrete benefits in processing efficiency, controllability, and adaptability that are not obtainable by human authors alone or by generic, static prompt-based generative systems.

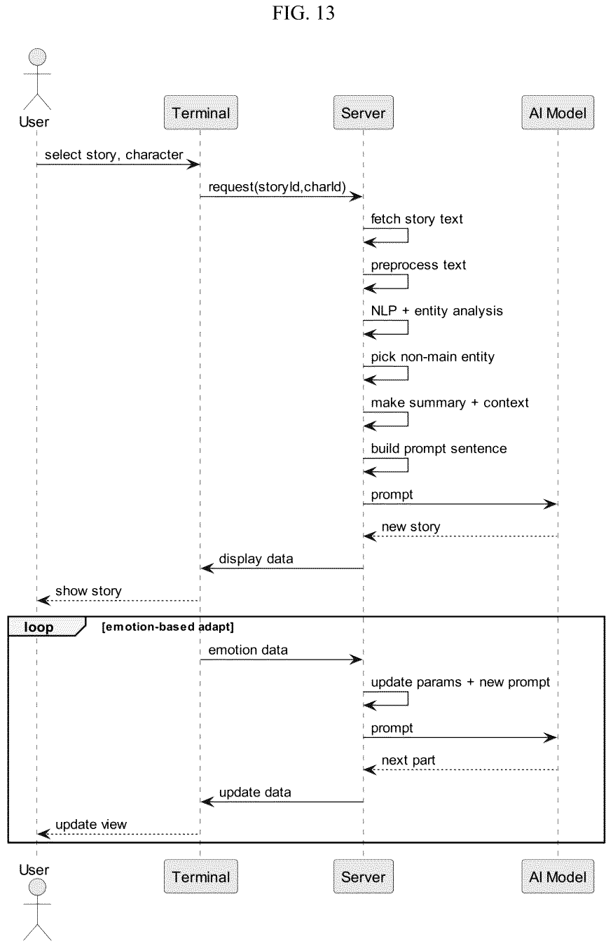

The following describes the processing flow using FIG. 13.

### Step 1:

The user operates the terminal to select a completed narrative and a non-main character.

The user views a list of completed narratives displayed on the terminal and taps one narrative entry. The user then selects a character that is not the original protagonist from a character list or search field provided by the terminal.
Input: User actions on the terminal user interface (taps, clicks, selections).
Processing: The terminal converts the user's selections into structured request data including at least a narrative identifier and a character identifier. The terminal may also attach user-specific context, such as language preference or desired story length.
Output: The terminal transmits a narrative-selection request message to the server via a network connection, for example using HTTPS with a JSON payload.

### Step 2:

The server acquires narrative text data corresponding to the selected completed narrative.
The server receives the narrative-selection request from the terminal and extracts the narrative identifier and character identifier. The server then calls one or more external content APIs to retrieve the full text of the completed narrative.
Input: Narrative-selection request (narrative identifier, character identifier, optional user preferences).

Processing: The server constructs an API request including the narrative identifier, sends the request via an HTTP client library, and receives a structured response containing narrative text in a format such as JSON or a markup format. The server parses the response, extracts contiguous narrative text fields (dialogue, narration, descriptions), and stores these fields as raw narrative records in storage.
Output: The server outputs raw narrative text and associated metadata (e.g., chapter markers, section labels) into a storage subsystem as raw narrative data.

### Step 3:

The server preprocesses the raw narrative data into normalized analysis target data.
The server loads the raw narrative text from storage and performs normalization operations.
Input: Raw narrative text and metadata retrieved from storage.
Processing: The server removes markup tags, normalizes character encodings (for example, converting to UTF-8), unifies whitespace, and segments the text into structural units such as chapters, scenes, and paragraphs using rule-based delimiters (e.g., chapter headings, blank lines). The server assigns indices to each structural unit and constructs an ordered data structure that maps narrative positions (chapter index, paragraph index) to text content.
Output: The server stores normalized analysis target data, consisting of tokenization-ready paragraphs with structural indices, in memory and persistent storage.

### Step 4:

The server performs natural language processing on the analysis target data to extract entities and linguistic annotations.
The server invokes a natural language processing pipeline implemented by a language processing library.
Input: Normalized analysis target data (paragraph structures with raw text content).
Processing: The server submits each paragraph to the NLP engine, which performs tokenization, morphological analysis, part-of-speech tagging, and dependency parsing. The server also applies named entity recognition to detect person entities and other narrative-relevant entities. For each paragraph, the server builds token objects containing token strings, lemmas, POS tags, and dependency relations, and builds entity objects indicating entity spans and categories.
Output: The server outputs an annotated narrative structure that associates each paragraph with tokens, syntactic information, and extracted entity mentions.

### Step 5:

The server aggregates entity mentions to construct a narrative entity table.
The server analyzes the extracted entity mentions to unify variations of names that refer to the same character.
Input: Annotated narrative structure containing token lists and entity mentions for each paragraph.
Processing: The server applies normalization rules, such as stripping honorifics, matching given and family names, and merging aliases. The server maps each mention to a canonical entity identifier. The server then counts mention occurrences per entity and stores mention positions (chapter index, paragraph index, token span) in an entity table. The server also computes basic statistics, such as total mention count per entity and distribution of mentions across chapters.
Output: The server outputs a narrative entity table with canonical entity identifiers, mention lists, and preliminary statistics.

### Step 6:

The server constructs an entity relationship graph and computes entity scores to identify main and non-main entities.
The server derives relationships between entities based on co-occurrence and narrative proximity.
Input: Narrative entity table, paragraph-level annotations, and structural indices.
Processing: The server scans each paragraph and registers co-occurrence events when multiple entities appear within the same paragraph or neighboring paragraphs. The server constructs a weighted graph where nodes represent entities and edges represent co-occurrence frequency or strength. The server calculates, for each entity, a score that combines normalized mention frequency, spread across chapters, and graph-based centrality (for example, degree centrality or a PageRank-like metric). The server identifies the entity with the highest score as the main entity and marks other entities as non-main entities, subject to threshold rules.
Output: The server outputs a main-entity identifier, a set of non-main entity identifiers, and an updated entity table with computed scores.

### Step 7:

The server selects the user-specified non-main entity and validates it as a new protagonist candidate.
The server uses the character identifier provided by the user to locate the corresponding non-main entity.
Input: User-selected character identifier and the set of non-main entity identifiers with scores.
Processing: The server maps the user-selected character identifier to a canonical entity identifier in the entity table. The server verifies that the selected entity is not the main entity and that it satisfies predefined conditions, such as minimum mention frequency or appearance in more than one chapter. If the selected entity does not satisfy the conditions, the server may either notify the terminal of an error or suggest alternative candidates.
Output: The server outputs a validated non-main entity identifier designated as the new protagonist candidate.

### Step 8:

The server generates summary information of the completed narrative.
The server compresses the full narrative into a shorter representation that preserves main events and entities.
Input: Analysis target data, entity table, and structural indices.
Processing: The server may call a summarization-capable generative AI model with a prompt instructing summarization, passing segments of the narrative as input and receiving a summary. Alternatively or additionally, the server may compute sentence-level scores based on entity density, position in the narrative, and emphasis markers, and select top-ranked sentences as an extractive summary. The server may combine abstractive and extractive methods. The server concatenates the selected or generated sentences into a coherent summary.
Output: The server outputs summary information text that concisely describes the narrative's main characters and principal events.

### Step 9:

The server extracts context segments focused on the non-main entity.
The server gathers all narrative portions where the new protagonist candidate appears.
Input: Analysis target data, validated non-main entity identifier, and entity mention positions.
Processing: The server iterates over the entity table to find all mentions of the non-main entity and, for each mention, selects the corresponding paragraph and neighboring paragraphs within a context window. The server merges overlapping windows and orders the resulting segments according to narrative position. The server annotates these segments with metadata such as time within the narrative and involved entities.
Output: The server outputs a set of context segments and derived context information that capture how the non-main entity participates in the original narrative.

### Step 10:

The server constructs a context-rich prompt sentence for the generative AI model.
The server assembles a multi-part instruction text that includes the summary and the context segments.
Input: Summary information, context segments, user preferences (e.g., desired length, tone).
Processing: The server composes a prompt sentence structured into labeled sections (e.g., work summary, character excerpts, generation instructions). The server embeds the summary under a summary heading and the context segments under a character-specific heading. The server then appends explicit instructions specifying that the non-main entity is to be treated as the new protagonist, that the original settings and principal events should be preserved, and that the narrative should be written from a particular viewpoint (e.g., first person) and within a specified length. Example prompt sentences include:
“Please generate a story from a new point of view, with the character “C” from the finished comic “B” as the main character. While building on the major events of the original story, write a story of approximately 3,000 words in the first person, focusing on “C's” internal description and conflicts.”
and
“You are a novelist. Below is a summary of the finished manga ‘B’ and some key scenes involving the side character ‘C’. Using this information, write a new story from C's first-person point of view. Keep the main plotline consistent with the original, but focus on C's hidden motives, feelings, and actions that were not fully revealed before. Length: about 3000 words.”
Output: The server outputs a finalized prompt sentence string to be supplied to the generative AI model.

### Step 11:

The server invokes the generative AI model with the constructed prompt sentence.
The server transmits the prompt sentence to a neural language model and obtains generated text.
Input: Prompt sentence, generation parameters (e.g., temperature, max tokens, top-p).
Processing: The server sends an API request containing the prompt sentence and parameters to the generative AI model endpoint. The generative AI model, implemented as a transformer-based neural network trained using gradient descent to minimize prediction error on large text corpora, processes the prompt by computing attention-weighted representations across tokens and predicting subsequent tokens. The model produces a sequence of token IDs that the server decodes into text. The server accumulates tokens until a stopping condition is reached, such as a maximum length or an end-of-sequence marker.
Output: The server outputs newly generated narrative text from the viewpoint of the non-main entity as new narrative information.

### Step 12:

The server post-processes the generated narrative text and prepares it for incremental adaptation.
The server ensures the generated text conforms to format and consistency expectations.
Input: Raw generated narrative text and internal narrative state (e.g., chapter position, last scene).
Processing: The server normalizes line breaks, inserts paragraph boundaries, and may segment the text into logical units such as chapters or scenes based on length and structural cues. The server performs basic checks, such as verifying that the new protagonist appears in the text and that the required viewpoint is apparently followed. The server updates its internal narrative state to record the extent of generation and may store checkpoints for later use in follow-up prompt sentences.
Output: The server outputs formatted narrative segments and updated narrative state ready for display and further adaptation.

### Step 13:

The server receives user emotion information in real time and updates narrative control parameters.
The server integrates emotion signals into its control logic for subsequent generation.
Input: User emotion information from a user state acquisition apparatus, including emotion labels and intensities, and the current narrative state.
Processing: The server compares current emotion values against target ranges defined for the current narrative segment. If user engagement appears low, the server adjusts parameters such as temperature and narrative development conditions (e.g., more action, faster pacing). If negative emotion intensity is too high, the server modifies constraints to soften tone or provide relief. The server encodes these changes into updated control parameters and formulates an additional prompt sentence referencing the last generated segment and specifying desired changes for the continuation (for example, “continue the story with more dynamic events” or “introduce a calmer, reassuring scene”).
Output: The server outputs updated control parameters and, when needed, new or supplemental prompt sentences for further calls to the generative AI model.

### Step 14:

The server generates additional narrative segments based on updated conditions and merges them with existing content.
The server uses the generative AI model iteratively to extend or revise the story.
Input: Additional prompt sentences, updated control parameters, and previously generated narrative segments.
Processing: The server calls the generative AI model again with the additional prompt sentences and control parameters, receives new text segments, and verifies that the continuation aligns with existing content by checking for contradictions and abrupt changes. The server may include a summary of the previous segment in the prompt to enforce continuity. The server then concatenates or merges the newly generated segments with stored narrative segments, updating structural indices and narrative state accordingly.
Output: The server outputs an updated full narrative text that incorporates emotion-responsive modifications and remains consistent across segments.

### Step 15:

The server converts the updated narrative text into display data and sends it to the terminal.
The server prepares the narrative for efficient rendering on the user's device.
Input: Updated full narrative text, narrative metadata (e.g., title, protagonist name), and display configuration.
Processing: The server formats the narrative into a structured representation (for example, a markup with heading tags and paragraph tags) and may paginate or section the text according to display constraints. The server bundles the structured text with metadata and transmits it to the terminal via HTTPS as display data.
Output: The server outputs display data representing the generated narrative and sends it to the terminal.

### Step 16:

The terminal renders the display data to present the narrative to the user.
The terminal converts structured narrative content into visual output.
Input: Display data received from the server.
Processing: The terminal parses the structured format and generates a layout using a graphical user interface library. The terminal applies font settings, colors, and spacing, and maps narrative sections to screen pages or scrollable views. The terminal updates the display so that the user can read newly generated or updated segments seamlessly, possibly highlighting updated sections.
Output: The terminal outputs screen display information to the display device, showing the generated narrative text to the user.

### Step 17:

The user reads the narrative and optionally provides explicit feedback.
The user consumes the content and may influence subsequent generation.
Input: Rendered narrative on the terminal display and interactive controls (buttons, sliders, feedback icons).
Processing: The user scrolls through the narrative, reads the content, and may operate feedback controls such as “more action,” “slower pace,” or ratings. The terminal captures these inputs and converts them into structured feedback messages. The terminal may also continue to send sensor data to the server for emotion analysis.
Output: The terminal transmits user feedback and any additional user state information to the server, enabling further adaptation of narrative generation in subsequent iterations.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented narrative generation systems typically treat a finished narrative as a static text source and merely append a mechanically generated continuation that is insensitive to the reader's evolving state. In such systems, a generation engine often receives a simple instruction text and raw narrative data, and directly outputs a continuation without intermediate, machine-optimized prompt construction, narrative structure extraction, or adaptive feedback. As a result, these systems suffer from several technical limitations.

First, existing narrative generation pipelines generally lack an intermediate processing layer that analyzes structure information, entity attributes, and major events of a finished narrative to construct machine-readable context for a generative AI model. Without such structured analysis, context passed to the model is either truncated heuristically or included in an unorganized manner, which causes inefficient token usage, increased computational load, and unstable output quality on resource-constrained hardware.

Second, typical systems do not integrate real-time emotion data from a terminal into the text-generation loop at the level of prompt engineering and iterative regeneration. Emotion signals, if used at all, are treated as high-level user preferences rather than low-level parameters that dynamically control prompt sentences and subsequent narrative development. This leads to a one-shot, non-interactive pipeline that cannot adaptively steer generation based on time-varying user states, and thus cannot effectively use limited bandwidth and processing cycles to produce content that remains aligned with the user's current engagement and affect.

Third, conventional architectures often separate client-side sensing and server-side generation in a loose, application-level manner. Emotion recognition, when present, is not tightly coupled to the generative model's invocation logic. There is no standardized mechanism for converting continuous emotion measurements into structured emotion labels and intensities, embedding them into prompt sentences as explicit parameters, and repeatedly invoking the generative AI model to refine, extend, or adjust narrative outputs. This reduces the technical capability of the system to function as an adaptive, closed-loop content generation engine that optimizes generation in response to streaming user signals.

Fourth, existing systems rarely support a unified mechanism by which a processor analyzes a finished narrative to select non-main entities, derive entity-centric viewpoint information, and construct entity-focused prompts that systematically cause a generative AI model to produce alternative-viewpoint narratives. Without structured extraction of scene information and viewpoint metadata, the generative model is forced to infer such context on its own, resulting in redundant computation, increased latency, and inconsistent narrative coherence.

Accordingly, there is a need for an improved computer-implemented narrative generation system that (i) performs structured analysis of finished narrative text to extract machine-usable context, (ii) programmatically generates optimized prompt sentences for a generative AI model, (iii) integrates real-time emotion data from a terminal into the prompt-generation and re-generation loop as low-level control parameters, and (iv) supports viewpoint-aware narrative generation, all within a coordinated, processor-controlled architecture. Such an improved system should enhance the technical efficiency, responsiveness, and controllability of narrative generation on computing hardware, beyond merely automating human creative work.

The specific processing by the specific processing unit 290 of the data processing device 12 in Application Example 2 is realized by the following means.

The present invention provides a server comprising a processor configured to analyze character information of a finished narrative using a language processing function to extract structure information of the narrative, attribute information of appearing entities, and information of major events, to generate a first prompt sentence that instructs a generative AI model to generate a sequel narrative or an alternative narrative on the basis of the extracted information and instruction information acquired from a user, to input the first prompt sentence and context information relating to the finished narrative into the generative AI model so as to cause the generative AI model to generate the sequel narrative or the alternative narrative and to acquire a generated result as narrative data, to receive, from a terminal device, emotion data representing a time-varying emotional state of the user obtained by analyzing state information of the user captured by an image acquisition function and a sound acquisition function, to generate an additional prompt sentence for the generative AI model on the basis of the emotion data and the narrative data, to input the additional prompt sentence and the narrative data into the generative AI model so as to cause the generative AI model to generate additional narrative data that dynamically adjusts development of the narrative in accordance with the emotional state of the user, and to cause presentation means to present at least one of the narrative data and the additional narrative data to the user. This enables the server to implement a closed-loop, processor-controlled narrative generation pipeline in which structured narrative analysis, machine-optimized prompt sentence construction, and real-time emotion feedback are integrated to efficiently control a generative AI model on computing hardware, thereby improving technical performance in terms of generation stability, responsiveness, and adaptive narrative control compared to conventional systems.

The term “finished narrative” refers to narrative content whose storyline has been completed and for which no further official episodes are added, including but not limited to text-based works such as novels, comics, scripts, and other narrative documents stored as character information in a storage medium.

The term “character information” refers to electronic text data representing at least part of a narrative, including sentences, paragraphs, chapters, and associated metadata, from which entities, events, and structural elements of the narrative can be extracted by a language processing function.

The term “language processing function” refers to a software-implemented natural language processing capability executed by a processor, which analyzes character information to perform at least one of tokenization, part-of-speech tagging, syntactic parsing, named entity recognition, co-reference resolution, and semantic analysis.

The term “structure information of the narrative” refers to data representing a logical or temporal arrangement of components of a narrative, including but not limited to chapter boundaries, scene boundaries, event sequences, and relationships among narrative segments derived by the language processing function.

The term “attribute information of appearing entities” refers to information representing properties of entities that appear in a narrative, including but not limited to names, roles, relationships, types, and other descriptive characteristics inferred from the character information.

The term “information of major events” refers to data indicating noteworthy occurrences in a narrative, such as conflicts, climaxes, resolutions, and turning points, identified by analyzing the character information and structure information.

The term “appearing entity” refers to any entity that appears within a narrative, including but not limited to characters, groups, objects, locations, and abstract concepts, which can be recognized as discrete entities by the language processing function.

The term “scene information” refers to information describing a localized portion of a narrative in which one or more appearing entities participate under certain circumstances, the scene information including at least text segments, temporal or spatial context, and entity participation data.

The term “viewpoint information” refers to data representing a narrative perspective centered on a particular appearing entity, including information specifying which entity is treated as a main character, what temporal and spatial span is covered, and how events are to be narrated relative to that entity.

The term “instruction information acquired from a user” refers to input data provided by a user through an interface of a terminal device, including but not limited to selections of titles or entities, request types such as sequel or alternative narrative, and free-form text instructions regarding desired narrative style or content.

The term “prompt sentence” refers to electronic text that encodes an instruction for a generative AI model, including at least one of narrative context, generation conditions, viewpoint constraints, and parameter settings, and that is input to the generative AI model as a basis for generating narrative data.

The term “first prompt sentence” refers to a prompt sentence generated by the processor on the basis of structure information, attribute information, information of major events, and instruction information acquired from the user, and used to cause the generative AI model to initially generate a sequel narrative or an alternative narrative.

The term “additional prompt sentence” refers to a prompt sentence generated by the processor after acquisition of narrative data and emotion data, the additional prompt sentence including information that instructs the generative AI model to modify, extend, or refine the narrative data in accordance with the emotional state of the user.

The term “generative AI model” refers to a computer-implemented artificial intelligence model configured to perform natural language generation, which receives a prompt sentence and optionally context information as input and outputs new character information corresponding to a narrative continuation or alternative narrative.

The term “context information relating to the finished narrative” refers to text data and structured metadata derived from the finished narrative, including at least parts of the original character information, structure information, attribute information of appearing entities, and information of major events, which are supplied to the generative AI model together with a prompt sentence.

The term “narrative data” refers to machine-generated character information output by the generative AI model, representing at least one of a sequel narrative, an alternative narrative, or an additional narrative segment derived from a finished narrative.

The term “sequel narrative” refers to narrative data that continues a storyline of a finished narrative beyond an original ending, while maintaining consistency with the structure information, entities, and events of the finished narrative.

The term “alternative narrative” refers to narrative data that reinterprets or reconfigures at least part of a finished narrative, including but not limited to narratives from different viewpoints, rewritten developments, or modified endings.

The term “terminal device” refers to an electronic device operated by a user and configured to communicate with the processor over a communication network, the electronic device including at least one of a display, an image acquisition function, and a sound acquisition function.

The term “image acquisition function” refers to hardware and software of a terminal device that cooperatively capture visual information of a user, such as facial images or body posture, using at least one imaging sensor.

The term “sound acquisition function” refers to hardware and software of a terminal device that cooperatively capture audio information of a user, such as speech or non-verbal vocalizations, using at least one acoustic sensor.

The term “state information of the user” refers to data captured by an image acquisition function and a sound acquisition function of a terminal device, representing physical or behavioral characteristics of the user, including at least one of facial expressions, gaze direction, and voice features.

The term “emotion analysis function” refers to a computer-implemented function that receives state information of the user and outputs emotion data by applying at least one of pattern recognition, statistical analysis, or machine learning to classify or estimate an emotional state of the user.

The term “emotion data” refers to information representing a time-varying emotional state of the user, including at least one of an emotion label, an emotion intensity, a confidence score, and a temporal index.

The term “time-varying emotional state” refers to a sequence of emotional states of the user that change over time, each emotional state being characterized by at least one emotion label and a corresponding intensity.

The term “emotion label” refers to a symbolic representation of a type of emotional state, including but not limited to happiness, sadness, anger, fear, surprise, and neutrality.

The term “emotion intensity” refers to a numerical or scaled value indicating a magnitude or degree of a corresponding emotion label, derived from emotion data.

The term “subjective state of the user” refers to an internal affective condition of the user, such as mood, arousal, or engagement level, inferred from emotion data generated by the emotion analysis function.

The term “presentation means” refers to one or more output components configured to present narrative data or additional narrative data to the user, including at least a display device, an audio output device, or a combination thereof.

The term “development of the narrative” refers to a progression of events, scenes, and emotional arcs within narrative data, including at least introduction, conflict, climax, and resolution phases.

The term “mood of the generated narrative” refers to a qualitative emotional tone or atmosphere of narrative data, such as being light, dark, hopeful, or tragic, which can be influenced by the emotion label and emotion intensity.

The term “ending of the generated narrative” refers to a concluding portion of narrative data that resolves or leaves open narrative threads, and whose content and tone can be adjusted in accordance with emotion data.

The term “closed-loop narrative generation pipeline” refers to a processing architecture in which narrative data generated by a generative AI model is presented to a user, emotion data about the user's response is acquired and analyzed, and additional prompt sentences are generated on the basis of the emotion data and the narrative data to invoke the generative AI model again, thereby iteratively adjusting subsequent narrative data.

In one embodiment, a server, a terminal, and a communication network cooperatively implement the claimed system. The server comprises at least one processor, a memory storing executable instructions and models, and a storage unit storing narrative data and user sessions. The terminal comprises a display, an image acquisition device such as a camera, a sound acquisition device such as a microphone, and a communication interface such as a wireless transceiver. The server and the terminal communicate through a packet-based network such as the Internet using secure transport protocols.

The server executes an operating system such as a general-purpose server operating system and a runtime environment such as a web application framework. The server further executes a set of application modules, including a language processing module, a prompt generation module, a generative AI interface module, a narrative management module, a session management module, and an emotion integration module.

The terminal executes a client application implemented as a web application in a browser or as a native mobile application. The terminal application includes a user interface module, an image and audio capture module, a local pre-processing module for user state data, and a communication module for sending and receiving structured messages to and from the server.

The server uses a language processing module to analyze character information of a finished narrative. The server stores the finished narrative as character strings in a database. The server loads a natural language processing library such as a statistical or neural text analysis toolkit into memory. The language processing module implements tokenization, part-of-speech tagging, syntactic dependency parsing, named entity recognition, and coreference resolution. The server represents intermediate results using explicit data structures, such as token arrays, dependency trees, and entity graphs.

The server generates structure information of the narrative by grouping tokens into sentences and paragraphs, by detecting section markers, and by constructing an event graph. The event graph is a directed graph in which nodes represent major events and edges represent temporal or causal relations between events. The server identifies major events using heuristic rules and statistical scores, such as frequency of entity mentions, presence of conflict verbs, and position near known narrative peaks such as climactic chapters. The server stores the structure information as a set of records linking text spans to event nodes.

The server generates attribute information of appearing entities by aggregating entity mentions identified by named entity recognition and by coreference resolution. The server assigns each entity an identifier and stores attributes such as entity type, approximate role (main, supporting, minor) derived from occurrence frequency and centrality in the event graph, and relational links to other entities. The server stores this attribute information in an entity table in the memory or storage.

The server generates information of major events by marking event nodes with importance scores and summarizing associated text spans into short descriptions. The server uses a summarization algorithm that selects sentences with high centrality scores in the event graph and compresses them into short phrases. The server stores these event summaries in an event table.

The server uses a prompt generation module to generate a prompt sentence. The server receives instruction information from the terminal, such as a request to generate a sequel, a request to generate an alternative viewpoint narrative, or free-form user text describing narrative constraints. The server merges the instruction information with the structure information, the attribute information, and the information of major events. The server uses rule-based templates to assemble a prompt sentence. For example, the server generates a base prompt of the form:
“You are a generative AI model. Based on the following context, generate a sequel to the finished narrative that continues the storyline consistently and respects the existing characters and events. Context: [context text].”

The server embeds context text that includes condensed descriptions of key events and entity attributes, for example:
“In the finished narrative, the main hero defeated the adversary in the final battle with the help of a supporting character. The supporting character remained unresolved and returned to a distant homeland.”

The server may generate different prompt variants according to the requested mode. If the user requests an alternative viewpoint from a non-main entity, the server refines the prompt sentence as:
“You are a generative AI model. Using the following context from the finished narrative, generate a new story from the viewpoint of a supporting character who did not have the main role in the original narrative. Treat the supporting character as the main character and describe events from that character's perspective. Context: [context text].”

If the user requests a general sequel, the server may generate:
“Based on the final chapter of the finished narrative, generate a continuation that shows what happens to the main characters after the original ending. Maintain consistency of tone and relationships. Context: [context text].”

The server interfaces with a generative AI model using a generative AI interface module. In one embodiment, the generative AI model is a transformer-based neural network language model stored on a separate computation service. The model includes an embedding layer, multiple multi-head self-attention layers, feed-forward layers, layer normalization, and a final projection layer that outputs token probabilities. The model has been pre-trained on a large corpus of text using a next-token prediction objective and then optionally fine-tuned on narrative-like data. The server does not change the model weights during inference, but uses model parameters such as maximum token length, sampling temperature, and top-k or top-p values to control generation.

The server supplies the prompt sentence and the context information relating to the finished narrative as input tokens to the generative AI model. The server encodes the input text into token identifiers according to a vocabulary of the model. The generative AI model executes attention computations in which each layer computes attention weights over the previous layer outputs, multiplies them by learned weight matrices, applies nonlinear activation functions, and combines results through residual connections. The model repeatedly computes next-token probabilities and selects output tokens according to the specified sampling strategy, thus generating narrative data as a sequence of tokens.

The server retrieves the output tokens, converts them back into text, and stores the text as narrative data. The narrative data may be a sequel narrative or an alternative narrative depending on the content of the prompt sentence. The server stores the narrative data together with metadata such as generation mode, used prompt sentence, and context snapshot in a narrative management module.

The terminal acquires state information of the user through the image acquisition device and the sound acquisition device. The terminal captures video frames of the user's face at a configured frame rate and captures audio samples of the user's speech or non-verbal sounds.

The terminal performs basic pre-processing, such as resizing images, normalizing pixel values, extracting spectrograms, or computing short-time Fourier transforms of the audio.

The terminal sends the pre-processed state information or derived features to an emotion analysis service executed locally or on a remote processing node.

In one embodiment, the terminal uses an emotion analysis function that includes a convolutional neural network for image-based emotion recognition and a recurrent or transformer-based neural network for audio-based emotion recognition. The image model processes the face region to output probabilities for emotion labels such as happiness, sadness, anger, surprise, fear, and neutrality. The audio model processes the spectrogram or feature sequence and outputs corresponding emotion probabilities. The terminal combines image and audio emotion estimates using a weighted average or another fusion algorithm to produce emotion data that includes an emotion label, an emotion intensity, and a time stamp.

The terminal sends the emotion data to the server using structured messages over the network. The server receives the emotion data and stores it in session memory associated with the user. The server may update a moving average of emotion intensities to stabilize transient fluctuations. The emotion integration module then derives a subjective state of the user from the emotion data, including a dominant emotion label and a corresponding intensity over a recent time window.

The server uses the emotion integration module to generate an additional prompt sentence.

The server combines the narrative data and the emotion data. The server may include the previously generated narrative as “Previous story” text in the prompt sentence, and may embed the emotion label and intensity in explicit instructions. For example, if the emotion label is sadness with high intensity, the server generates:
“Continue the following story in a way that gently shifts the mood toward hope while respecting the reader's current feeling of sadness. Previous story: [narrative data].”

If the emotion label is surprise with high intensity, the server generates:
“Continue the following story by adding an unexpected but coherent development that increases the sense of surprise and engagement. Previous story: [narrative data].”

The server inputs the additional prompt sentence together with at least part of the narrative data into the generative AI model. The model again executes transformer computations and generates additional narrative data. By incorporating the emotion label and intensity as explicit parameters in the prompt sentence, the server forces the generative AI model to condition its generation on the user's current emotional state, rather than only on static narrative context. The server presents the narrative data and/or the additional narrative data to the user by sending the text to the terminal for rendering on the display or for audio rendering using a text-to-speech engine.

The server uses specific data structures and algorithms to improve technical performance.

The server stores narrative context and user sessions in a structured form, such as key-value stores and indexed tables, which permit efficient retrieval of only those text portions and entity records needed for prompt construction. The server pre-computes and caches structure information and entity attributes for frequently accessed finished narratives. By doing so, the server reduces the number of tokens that must be sent to the generative AI model, thereby reducing network transmission volume and inference time.

The server uses a prompt length optimization algorithm that examines the token length of candidate prompt sentences and context segments. The server truncates or summarizes portions that contribute less to narrative coherence according to a scoring function that weights events and entities by relevance to the requested mode and the selected appearing entity. This optimization reduces the token count and therefore the computational cost of transformer attention operations, which are quadratic in sequence length. Consequently, the system improves processing speed and reduces resource usage compared to naive approaches that send entire narratives to the model.

The server uses a viewpoint selection algorithm when the user requests a narrative from a non-main entity. The server identifies an appearing entity that does not have a main role by computing a centrality measure in the event graph and selecting entities with centrality below a threshold while still having multiple event participations. The server then extracts scene information that includes appearances of this entity and constructs viewpoint information that orders scenes chronologically from the perspective of this entity. By explicitly generating viewpoint information and embedding it into the prompt sentence, the server reduces the burden on the generative AI model to infer viewpoint from raw text. This structured preparation leads to more stable narrative coherence and requires fewer regeneration attempts, which improves overall throughput.

The generative AI model itself is trained in a specific manner that supports fine-grained control. In one embodiment, the model is a transformer language model trained with a cross-entropy loss function on next-token prediction across a large corpus. During fine-tuning for narrative tasks, the training data includes samples with explicit control codes for mood, viewpoint, and narrative type, such as “[mood: happy] [viewpoint: side character] [type: sequel]” followed by context and continuation. The model therefore learns a mapping between textual control signals and narrative style characteristics. The server leverages this training by encoding the emotion label and other parameters into natural language segments or control tokens in the prompt sentence, thereby enabling the model to adjust narrative output in response to explicit parameters.

The server uses a narrative consistency checking module to avoid certain types of contradictory output. The module may use additional language processing, such as coreference checking and entity-state tracking, to detect when new narrative data creates direct contradictions with known facts from the finished narrative. If contradictions exceed a threshold, the server can generate a revised prompt sentence emphasizing respect for specific constraints, such as “Do not contradict the fact that the supporting character remained alive at the end of the original narrative.” The server thereby reduces the need for human post-editing and improves the reliability of the automatic pipeline.

The technical effects of these configurations extend beyond mere automation of human creative tasks. By decomposing the narrative generation pipeline into structured language analysis, optimized prompt sentence construction, transformer-based generation, and emotion-driven re-generation, the server improves computational efficiency and output controllability. The prompt length optimization and event/entity scoring directly reduce the length of sequences passed to attention layers, improving processing time on existing hardware. The viewpoint-aware context selection reduces redundant computation and memory usage by avoiding unnecessary context. The explicit encoding of emotion parameters into prompt sentences, together with the training of the generative AI model to understand such parameters, allows the system to converge to desired narrative styles with fewer retries and less exploratory generation. These improvements reduce server load, network bandwidth consumption, and latency experienced by the user.

The terminal contributes to technical effects by pre-processing user state data and by performing local aggregation of emotion estimates before sending emotion data to the server. By compressing raw image and audio data into compact emotion data, the terminal reduces network transmission volume and server-side processing requirements. This division of labor contributes to overall system scalability.

The system uses non-conventional processing sequences compared to typical content delivery systems. The system builds a closed-loop narrative generation pipeline that repeatedly measures user emotion as a feedback signal and uses this signal to generate additional prompt sentences, which in turn change the behavior of the generative AI model. The server therefore controls the model as a dynamic component in a feedback-controlled system, rather than as a one-time text generator. This architecture yields a technically improved adaptive content engine that adjusts narrative generation in near-real time based on streaming biometric-like signals.

Alternative embodiments are possible. In one alternative embodiment, the server executes the emotion analysis function rather than the terminal. The terminal streams state information such as compressed video or audio to the server, and the server runs convolutional and recurrent neural networks to generate emotion data. The server then performs the same integration of emotion data into additional prompt sentences. In another embodiment, the generative AI model is hosted on the same hardware as the server and uses local GPU accelerators. In this configuration, the server can adjust model parameters such as number of layers used or precision mode (full precision or reduced precision) based on current load, further improving computational efficiency.

In another embodiment, the server uses different generative AI models for different purposes, such as a smaller model for initial draft generation and a larger model for refinement based on emotion data. The server can select the model dynamically based on narrative length, user device capabilities, or network conditions, thereby optimizing resource usage.

In yet another embodiment, the terminal incorporates a local generative AI model for short narrative segments, and the server coordinates between local and remote generation. The server may send compressed prompt descriptors to the terminal, and the terminal reconstructs prompt sentences and generates narrative segments locally. This configuration further reduces network traffic and latency in scenarios where network connectivity is limited.

In all embodiments, the server, the terminal, and the generative AI model operate in a coordinated manner to implement the functions recited in the claims. The combination of structured language analysis, explicit prompt sentence engineering, transformer-based generative AI, and emotion-driven feedback yields a computer-implemented narrative generation system that improves processing speed, reduces computational load, enhances narrative coherence control, and realizes a technically advantageous closed-loop generation pipeline that is not achievable by conventional, static text generation systems.

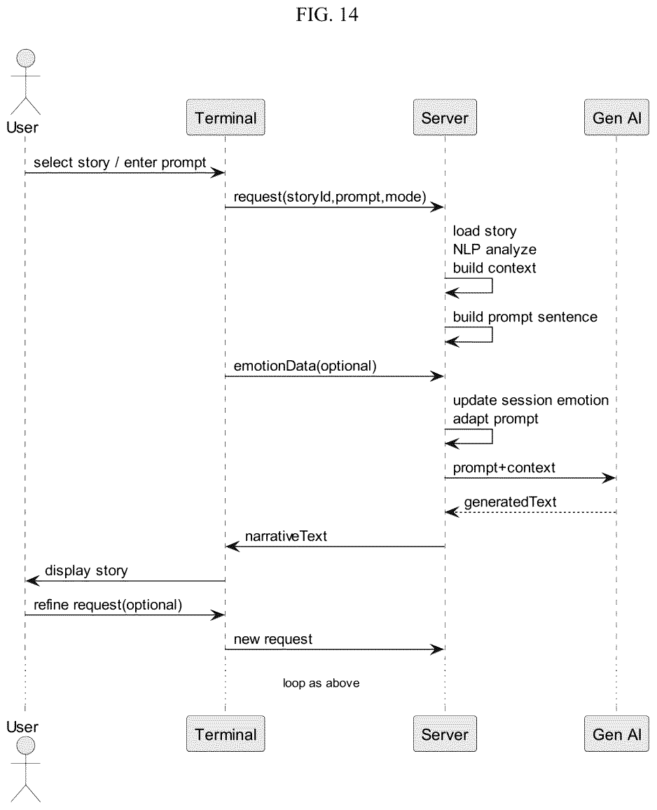

The following describes the processing flow using FIG. 14.

### Step 1:

User operates the terminal to specify generation conditions.
User selects a finished narrative from a list displayed on the terminal, optionally selects an appearing entity such as a non-main character, and optionally inputs a free-form instruction as a prompt sentence, for example, “Generate a sequel to the finished narrative that continues the story in a sad tone.”
Input: User selections (narrative identifier, optional entity identifier) and optional user-entered prompt sentence.
Output: A request message including the selected identifiers, the user-entered prompt sentence, and mode flags (e.g., sequel, alternative viewpoint, emotion-adaptive) stored in the terminal's memory and prepared for transmission.
Terminal packages these items into a structured data object and displays a confirmation to the user.

### Step 2:

Terminal transmits the user request to the server.
Terminal sends the structured request message to the server over a network connection using a communication protocol such as HTTPS.
Input: Request message comprising narrative identifier, optional entity identifier, user-entered prompt sentence, and mode flags.
Output: A network packet stream addressed to the server and a local state on the terminal indicating that a story-generation request is pending.
Terminal activates a loading indicator on the display and temporarily disables duplicate submission buttons.

### Step 3:

Server receives and validates the user request.
Server accepts the incoming network data, decodes the message, and checks that the narrative identifier exists in a narrative database and that the entity identifier, if present, is associated with that narrative.
Input: Request message received from the terminal.
Output: A validated request structure or an error response if validation fails.
Server performs data checks such as string length limits on the user-entered prompt sentence and normalizes character encoding to a canonical format.

### Step 4:

Server retrieves finished narrative text and associated metadata.
Server queries a storage unit, such as a relational database, to obtain the full text or selected sections of the finished narrative, along with stored metadata such as chapter boundaries and precomputed indices.
Input: Validated narrative identifier from the request.
Output: Narrative text (character information) and metadata structures representing chapter indices and pre-tagged segments.
Server loads these data into memory-resident objects to allow efficient processing in subsequent steps.

### Step 5:

Server performs language analysis on the narrative text.
Server executes a language processing function that tokenizes the narrative text into tokens, segments text into sentences, applies part-of-speech tagging, and constructs dependency parse trees for each sentence.
Input: Raw narrative text from the storage unit.
Output: Token arrays, sentence lists, and dependency structures representing grammatical relations.
Server uses these intermediate structures to compute further features such as subject-verb-object triplets and clause boundaries.

### Step 6:

Server extracts entities, structure information, and major events.
Server runs named entity recognition and coreference resolution to identify appearing entities and resolve references across the narrative. Server constructs an event graph by clustering sentences into events based on verb types, temporal markers, and entity co-occurrence.
Input: Token arrays, sentence lists, dependency structures, and metadata.
Output: Entity records with attributes (entity identifiers, types, roles), structure information describing narrative segments and chapter layout, and a set of major events with importance scores.
Server calculates importance scores using data operations such as frequency counts, graph centrality measures, and positional weighting near the ending of the narrative.

### Step 7:

Server selects context segments and builds condensed context text.
Server determines which narrative segments and events are relevant based on the mode (e.g., sequel or alternative viewpoint) and the selected entity. Server selects segments by filtering events and scenes that involve the selected entity or that occur near the narrative ending.
Input: Entity records, structure information, major events, mode flags, and optional entity identifier.
Output: A list of selected text segments and a condensed context text string.
Server performs data processing by concatenating key sentences and generating short summaries for each selected event, then merges them into a single context text that fits length constraints for the generative AI model.

### Step 8:

Server constructs an initial prompt sentence for the generative AI model.
Server merges the condensed context text, user-entered instruction (if present), and mode flags into a structured prompt sentence that encodes explicit instructions for narrative generation.
Input: Condensed context text, user-entered prompt sentence, and mode flags.
Output: A first prompt sentence that includes control phrases such as “You are a generative AI model” and detailed instructions such as “generate a sequel narrative” or “generate an alternative narrative from the viewpoint of the supporting entity.”
Server may perform string operations to insert parameter placeholders for mood or viewpoint and then fill them with computed values, such as “sad tone” or “supporting character viewpoint.”

### Step 9:

Terminal captures user state information for emotion analysis (if emotion-adaptive mode is enabled).
Terminal activates the camera and microphone to capture image frames of the user's face and audio samples of the user's voice while the user waits or reads.
Input: Raw sensor data from the camera and microphone.
Output: Pre-processed state information such as resized face images and audio feature vectors (e.g., spectrograms).
Terminal performs local data operations such as cropping face regions, normalizing pixel values, computing Mel-frequency cepstral coefficients, and buffering time-stamped frames.

### Step 10:

Terminal generates emotion data and sends it to the server.
Terminal applies an emotion analysis function that runs one or more neural network models on the pre-processed state information to classify emotions and compute intensities.
Input: Pre-processed image and audio features.
Output: Emotion data containing at least one emotion label, an emotion intensity value, and a time stamp.
Terminal summarizes multiple frame-level estimates into a smoothed emotion state using averaging or exponential smoothing, and then transmits the resulting emotion data to the server as a compact structured message.

### Step 11:

Server integrates emotion data into session state.
Server receives emotion data from the terminal and associates it with the current user session.
Server may maintain a rolling window of recent emotion data and compute a dominant emotion label and overall intensity.
Input: Emotion data messages containing emotion label, intensity, and time stamp.
Output: Updated session state that includes a dominant emotion label and a normalized intensity value.
Server performs data operations such as weighting more recent emotion samples more heavily and discarding outdated samples outside a predetermined time window.

### Step 12:

Server adapts or augments the prompt sentence based on emotion data.
Server modifies the first prompt sentence or generates an additional prompt sentence by inserting explicit instructions that reflect the user's emotional state, such as “fit a reader who is currently feeling sad” or “increase the sense of surprise.”
Input: First prompt sentence, condensed context text, narrative mode, and session emotion state (dominant label and intensity).
Output: An emotion-aware prompt sentence that encodes mood parameters and narrative control constraints.
Server performs string interpolation operations to embed descriptors of the emotion label and intensity into the prompt, for example, by adding “gentle, hopeful ending for a sad reader” or “highly surprising twist for an engaged reader.”

### Step 13:

Server sends the prompt sentence and context to the generative AI model.
Server tokenizes the final prompt sentence and context text into input tokens using the vocabulary of the generative AI model and sends these tokens via an API or local function call to the model.
Input: Emotion-aware prompt sentence and context text.
Output: A sequence of token identifiers formatted according to the generative AI model's input specification and a network or inter-process message invoking model inference.
Server sets model parameters such as maximum token length, sampling temperature, and top-k or top-p thresholds before initiating generation.

### Step 14:

Generative AI model generates narrative data.
Generative AI model processes the input tokens through multiple transformer layers, performing matrix multiplications, self-attention operations, and non-linear activations to compute a probability distribution over output tokens at each step.
Input: Tokenized prompt sentence and context tokens from the server.
Output: A sequence of output token identifiers representing generated narrative data.
Generative AI model iteratively samples or selects next tokens until it reaches a stop condition such as an end-of-sequence token or the maximum token limit, thereby computing a coherent narrative continuation or alternative narrative segment.

### Step 15:

Server post-processes the generated narrative data.
Server converts the output token identifiers back into text and performs cleanup operations such as removing extraneous leading phrases, fixing spacing, and normalizing punctuation.
Input: Output token sequence from the generative AI model.
Output: Cleaned narrative text stored as narrative data along with metadata such as generation time, applied emotion parameters, and prompt identifiers.
Server may also segment the text into paragraphs or chapters by detecting sentence boundaries and inserting line breaks for display purposes.

### Step 16:

Server constructs additional prompt sentences for iterative adaptation (if further refinement is requested).
Server uses the narrative data and updated emotion data to create additional prompt sentences for subsequent generation rounds. For example, if the user indicates a desire for a happier ending, the server generates a prompt such as “Rewrite the following ending to introduce a more hopeful resolution.”
Input: Existing narrative data, updated session emotion state, and any new user instructions from the terminal.
Output: Additional prompt sentences that instruct the generative AI model to refine, extend, or modify portions of the narrative.
Server may insert excerpts of previous narrative data as “Previous story” sections in the additional prompt sentences, specifying exact segments to be expanded or altered.

### Step 17:

Server transmits the narrative data to the terminal.
Server serializes the narrative text and its metadata into a response message and sends it back to the terminal through the network.
Input: Narrative data (and additional narrative data if iterative refinement has been performed).
Output: A structured response containing the narrative text, generation mode, and related metadata, delivered to the terminal.
Server logs performance metrics such as latency and token counts for monitoring and optimization.

### Step 18:

Terminal renders the narrative to the user.
Terminal receives the response message, extracts the narrative text, and displays it to the user using a text rendering component. Terminal may also provide scroll controls, font size adjustments, and a button to request further continuation or an alternative version.
Input: Response message containing narrative text and metadata.
Output: Visual or auditory presentation of the narrative on the terminal, such as formatted text on the screen or synthesized speech via a text-to-speech module.
Terminal updates its interface state to allow the user to trigger additional operations, such as “Generate more,” “Change viewpoint,” or “Change mood.”

### Step 19:

User evaluates the narrative and optionally issues follow-up instructions.
User reads or listens to the generated narrative, reacts emotionally, and may enter further instructions such as “Continue this story with a joyful ending” or “Retell the last scene from another character's viewpoint.”
Input: Previously presented narrative and user's internal evaluation.
Output: New user-entered prompt sentence or selection of additional options on the terminal interface.
Terminal captures these new inputs, updates the request message, and prepares to repeat the cycle by sending another request to the server.

### Step 20:

Terminal continuously captures and updates emotion data during interaction (in adaptive mode).
Terminal continues to capture image and audio streams while the user interacts with the narrative, periodically recomputes emotion data, and sends updates to the server.
Input: Ongoing sensor data from the camera and microphone, and current interaction state.
Output: Time-stamped streams of updated emotion data reflecting changes such as increased engagement, surprise, or satisfaction.
Terminal aggregates these updates at a configurable interval to balance responsiveness and network load, thereby enabling the server to continuously adapt subsequent prompt sentences and narrative generations.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

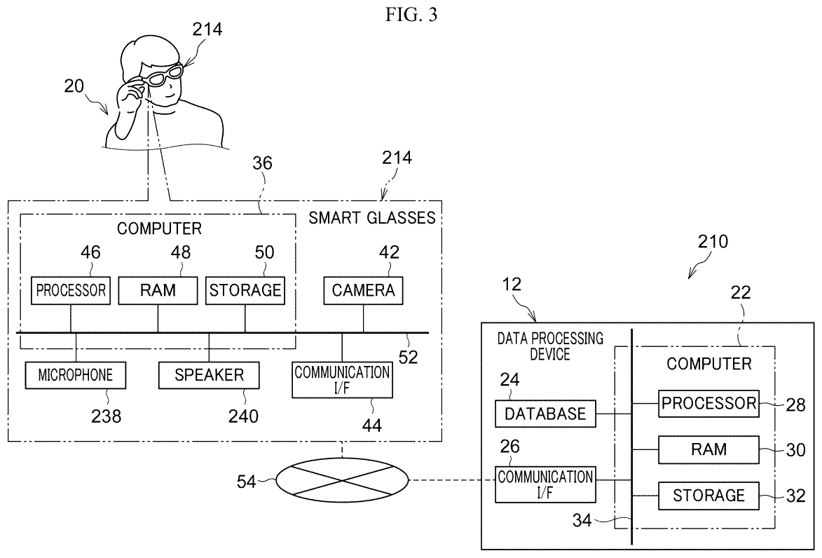

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

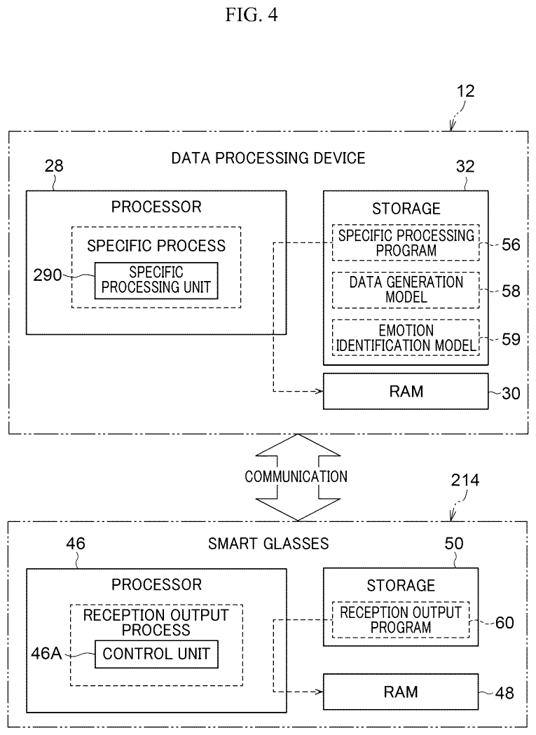

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

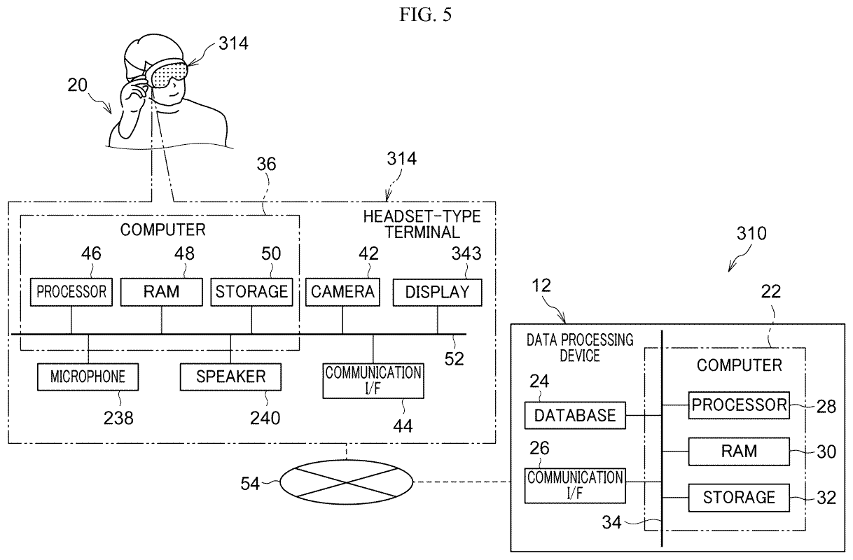

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

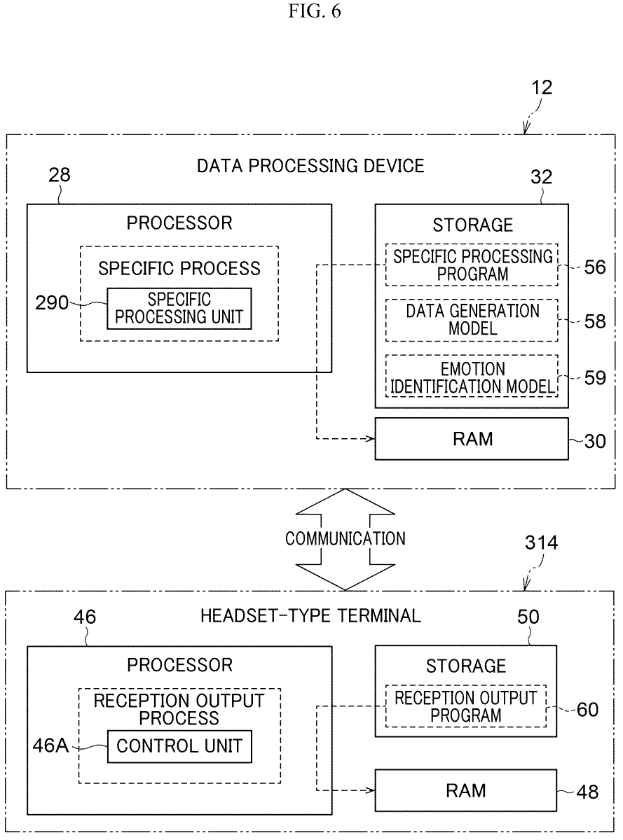

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

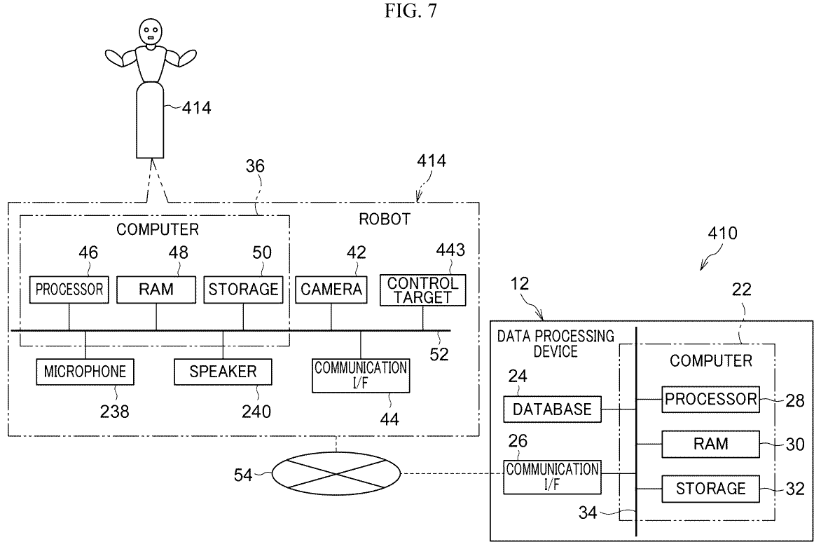

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

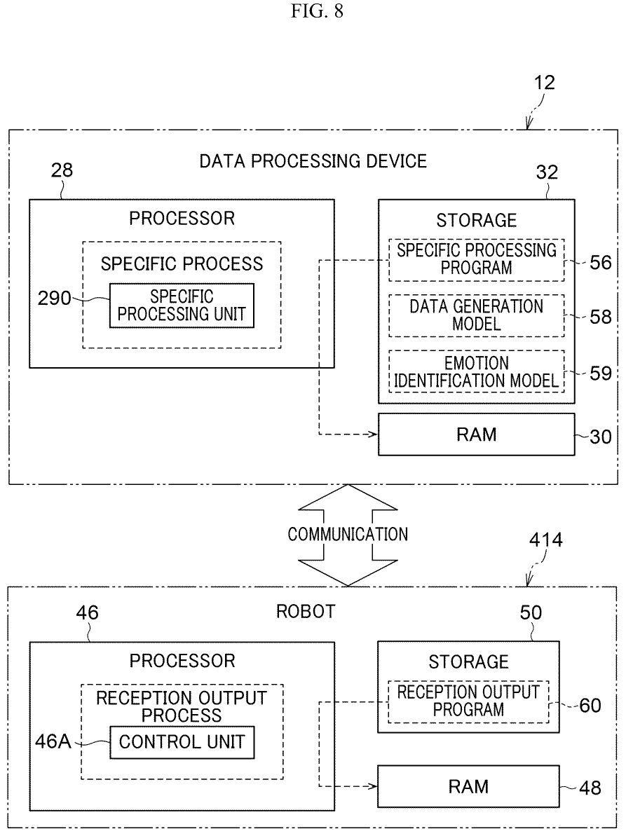

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

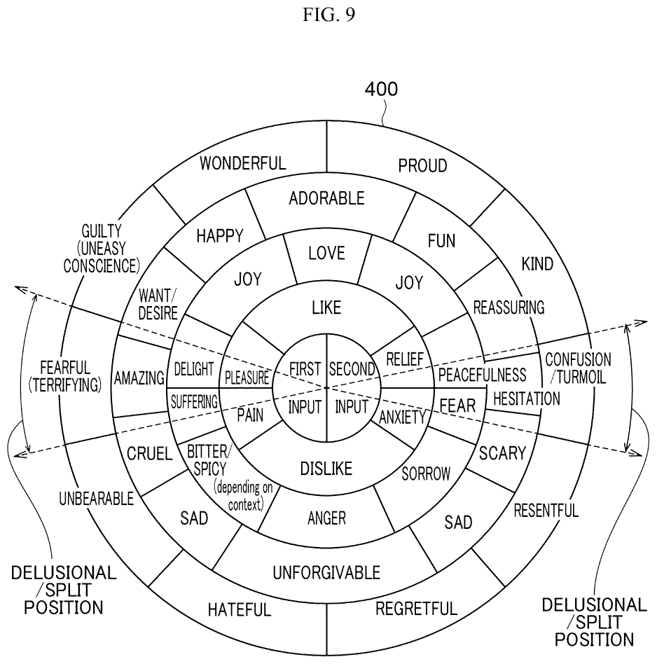

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

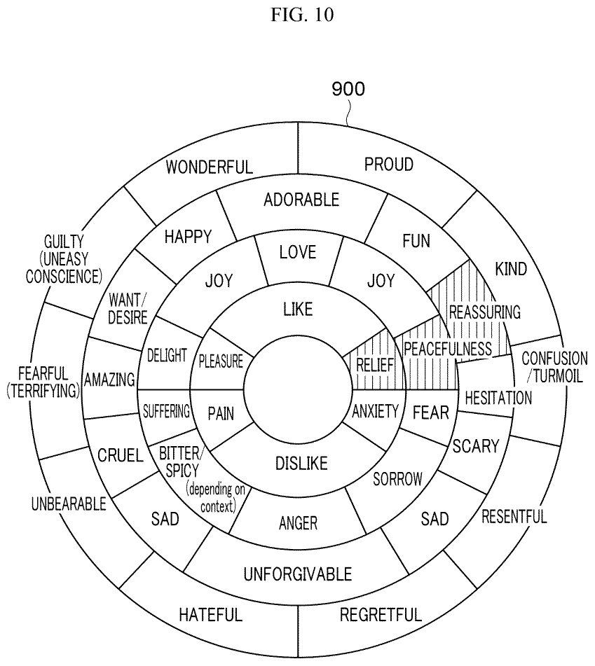

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor and a memory storing instructions that, when executed by the processor, cause the processor to:
acquire, from a storage medium, final-part text data of a completed document based on identification information of the completed document, and analyze the final-part text data by using a natural language processing algorithm to generate analysis information including subject information of the document and relationship information between appearing entities;
construct, based on the analysis information and the final-part text data, a prompt sentence that is an instruction sentence for a generative AI model, the prompt sentence including at least a title of the document, the subject information, the relationship information between the appearing entities, and summary information of the final-part text data;
transmit, via a communication interface to an external generative AI model, the prompt sentence and generation conditions, and acquire, from the external generative AI model, generated-document text data that is a continuation of the completed document;
execute formatting processing and content-checking processing on the generated-document text data to generate display-structured data, and transmit the display-structured data to a terminal device;
control presentation of the generated-document text data on a display device of the terminal device, and accept, in response to an operation input from a user, viewing of the generated-document text data and a request for regeneration of the generated-document text data;
obtain emotion-state information of the user by using an emotion recognition function, and modify, based on the emotion-state information, at least one of the prompt sentence and the generation conditions so as to adjust content of the generated-document text data.

### Supplementary 2

The system according to supplementary 1,
wherein the processor is configured to identify, from the final-part text data, a low-prominence entity among the appearing entities based on occurrence frequency, include viewpoint information centered on the low-prominence entity in the analysis information, and construct the prompt sentence so as to instruct the generative AI model to generate the generated-document text data as a document from a new viewpoint in which the low-prominence entity is treated as a main entity.

### Supplementary 3

The system according to supplementary 1,
wherein the processor is configured to combine emotion data obtained from the emotion recognition function with the analysis information and the generation conditions, reflect the emotion data in the prompt sentence, and control the generative AI model so that, during generation of the generated-document text data, at least one of narrative development, writing style, and length of the generated-document text data is adjusted according to the emotion data.

### Application Example 1

### Supplementary 1

A system comprising a processor,
wherein the processor is configured to
parse text information of completed content and generate a prompt sentence for instructing a generative AI model to generate subsequent text information of the content based on a result of the parsing,
input the prompt sentence and the text information of the completed content to the generative AI model and generate, by using the generative AI model, subsequent text information of the content,
divide the subsequent text information into a plurality of scene units and, for each scene unit, extract appearance entities, position information, object information, and action information and structure the extracted information as scene structure information,
generate resource mapping information by associating, based on the scene structure information, each appearance entity and the position information with virtual display resources, and generate configuration information for visual representation based on the resource mapping information,
generate visual content corresponding to the subsequent text information by using a visualization processing platform based on the configuration information for visual representation and cause a user terminal to present the visual content,
acquire selection operations or motion information from a user and recognize an emotional state of the user as emotion information that changes over time, and
generate an additional prompt sentence for dynamically adjusting development of the subsequent text information based on the emotion information and the selection operations, and sequentially update the subsequent text information by inputting the additional prompt sentence to the generative AI model again.

### Supplementary 2

The system according to supplementary 1,
wherein the processor is configured to
extract, from appearance entities included in the completed content, an appearance entity that does not have a main role, and generate a prompt sentence for instructing the generative AI model to generate new subsequent text information from a new viewpoint focusing on the extracted appearance entity.

### Supplementary 3

The system according to supplementary 1,
wherein the processor is configured to
change the scene structure information and the resource mapping information of the subsequent text information in generating the subsequent text information based on the prompt sentence by using the generative AI model, in consideration of the emotion information obtained from emotion recognition processing and information regarding the selection operations of the user, thereby adjusting development of the visual content.

### Example 2

### Supplementary 1

A system comprising a processor,
wherein the processor is configured to
acquire character information of a completed narrative from an external information providing apparatus, perform preprocessing on the character information, and store the preprocessed character information as analysis target character information,
perform natural language processing on the analysis target character information, the natural language processing including at least morphological analysis, tokenization, part-of-speech tagging, and entity extraction for narrative entities, and identify a main entity and a non-main entity in the narrative on the basis of at least an appearance frequency of each entity, an appearance position of each entity, and interrelationships among the entities,
generate summary information of an entire narrative on the basis of the analysis target character information and extract a character string section corresponding to a scene in which the non-main entity is involved, thereby generating context information related to the non-main entity,
construct a prompt sentence on the basis of the summary information and the context information, the prompt sentence instructing generation of a narrative from a different viewpoint while maintaining a setting and principal events of the completed narrative and designating the non-main entity as a new protagonist, and generate the prompt sentence as input data to a generative AI model,
cause the generative AI model to operate by using the prompt sentence as input and generate new narrative character information described from a viewpoint of the non-main entity,
acquire emotion information of a user in real time from a user state acquisition apparatus and, in accordance with the emotion information, dynamically update at least one of an additional prompt sentence, a control parameter, and additional input data for the generative AI model so as to sequentially adjust development content of the new narrative character information,
convert the new narrative character information into display data for a display apparatus and transmit the display data to a terminal via a communication apparatus, and
cause the terminal to convert the received display data into screen display information and visually present the screen display information to the user.

### Supplementary 2

The system according to supplementary 1,
wherein the processor is configured to
select, as the non-main entity, an entity that appears in the completed narrative but is not identified as the main entity by the natural language processing, and determine attribute information and action information to be emphasized in the prompt sentence on the basis of at least an appearance frequency of the non-main entity, diversity of scenes in which the non-main entity appears, and relationships between the non-main entity and other entities.

### Supplementary 3

The system according to supplementary 1,
wherein the processor is configured to
change, on the basis of an emotion label or an emotion intensity indicated by the emotion information, at least one of narrative development conditions, style conditions, and psychological description conditions of entities in the prompt sentence for the generative AI model, and connect a story portion regenerated in units of a chapter, a scene, or a paragraph so as to be consistent with an already generated story portion, thereby outputting updated narrative character information.

### Application Example 2

### Supplementary 1

A system comprising a processor and a terminal device,
wherein the processor is configured to
analyze character information of a finished narrative using a language processing function to extract structure information of the narrative, attribute information of appearing entities, and information of major events, and to generate a prompt sentence that instructs a generative AI model to generate a sequel narrative or an alternative narrative on the basis of the extracted information and instruction information acquired from a user,
and to input the prompt sentence and context information relating to the finished narrative into the generative AI model so as to cause the generative AI model to generate the sequel narrative or the alternative narrative, and to acquire a generated result as narrative data, and the terminal device is configured to
acquire state information of the user from an image acquisition function and a sound acquisition function, analyze the state information using an emotion analysis function to generate emotion data representing a time-varying emotional state of the user, and transmit the emotion data to the processor,
and the processor is further configured to
generate an additional prompt sentence for the generative AI model on the basis of the emotion data and the narrative data, and input the additional prompt sentence and the narrative data into the generative AI model so as to cause the generative AI model to generate additional narrative data, thereby dynamically adjusting development of the narrative in accordance with the emotional state of the user,
and to cause presentation means to present at least one of the narrative data and the additional narrative data to the user.

### Supplementary 2

The system according to supplementary 1,
wherein the processor is configured to
analyze character information of the finished narrative to extract scene information including an appearing entity that does not have a main role, generate viewpoint information centering on the appearing entity on the basis of the scene information, generate a prompt sentence including the viewpoint information and attribute information relating to the appearing entity, and cause the generative AI model to generate a new narrative from a viewpoint of the appearing entity as a main character.

### Supplementary 3

The system according to supplementary 1,
wherein the processor is configured to
determine an emotion label and an emotion intensity indicating a subjective state of the user on the basis of the emotion data, generate a prompt sentence including the emotion label and the emotion intensity as parameters, and input the prompt sentence into the generative AI model so as to cause the generative AI model to generate the sequel narrative or the alternative narrative, thereby controlling a mood, development, and ending of the generated narrative in accordance with the emotion data.

What is claimed is:

1. A system comprising:
circuitry configured to:
receive, via a communication interface coupled to a packet-switched network, identification information of a completed document from a terminal device;
retrieve, from a storage medium, final-part text data of the completed document based on the identification information;
analyze the final-part text data using a natural language processing algorithm to generate analysis information comprising subject information of the completed document and relationship information between appearing entities;
construct a prompt sentence for a generative neural network model based on the analysis information and the final-part text data, the prompt sentence encoding the subject information, the relationship information, and summary information;
transmit the prompt sentence and generation conditions to the generative neural network model and acquire generated-document text data from the generative neural network model;
execute formatting processing and content-checking processing on the generated-document text data to generate display-structured data, and transmit the display-structured data via the communication interface to the terminal device; and
obtain emotion-state information of a user and modify, based on the emotion-state information, at least one of the prompt sentence and the generation conditions so as to adjust at least one of narrative development, writing style, and length of the generated-document text data.

2. The system according to claim 1, wherein the circuitry is configured to tokenize the final-part text data, assign part-of-speech tags to resulting tokens, and compute syntactic dependency relationships to extract the subject information and the relationship information.

3. The system according to claim 2, wherein the circuitry is configured to detect named entities in the final-part text data and compute occurrence frequencies for each entity to identify entity prominence scores.

4. The system according to claim 3, wherein the circuitry is configured to identify a low-prominence entity among the appearing entities based on the occurrence frequencies, incorporate viewpoint information centered on the low-prominence entity into the analysis information, and control the generative neural network model via the prompt sentence so that the generated-document text data is generated as a document from a new viewpoint in which the low-prominence entity is treated as a main entity.

5. The system according to claim 4, wherein the circuitry is configured to extract attribute information of the low-prominence entity and generate an additional prompt sentence incorporating the attribute information and the viewpoint information.

6. The system according to claim 1, wherein the circuitry is configured to obtain the emotion-state information by processing at least one of facial image data, voice signal data, and physiological signal data received from the terminal device using an emotion recognition model.

7. The system according to claim 6, wherein the circuitry is configured to determine an emotion label and an emotion intensity value based on the emotion-state information, and incorporate the emotion label and the emotion intensity value as generation condition parameters for the generative neural network model.

8. The system according to claim 7, wherein the circuitry is configured to modify the generation conditions by adjusting at least one of output length, temperature, and tone parameters of the generative neural network model based on the emotion intensity value.

9. The system according to claim 8, wherein the circuitry is configured to monitor changes in the emotion-state information over successive interaction turns and update the generation condition parameters based on the monitored changes to adaptively modulate narrative development.

10. The system according to claim 1, wherein the circuitry is configured to construct the prompt sentence to include a title of the completed document, the subject information, the relationship information, and the summary information as structured fields encoding constraints for the generative neural network model.

11. The system according to claim 10, wherein the circuitry is configured to transmit the prompt sentence to the generative neural network model via an external API endpoint and receive the generated-document text data in response.

12. The system according to claim 11, wherein the circuitry is configured to execute content-checking processing by evaluating the generated-document text data against one or more predetermined criteria comprising coherence, length, and content policy compliance, and to modify or filter portions of the generated-document text data that fail the predetermined criteria.

13. The system according to claim 12, wherein the circuitry is configured to execute formatting processing by applying paragraph structuring and heading insertion to the generated-document text data to produce the display-structured data for rendering on a display device of the terminal device.

14. The system according to claim 1, wherein the circuitry is configured to store interaction history comprising prior prompt sentences, generation conditions, and generated-document text data, and to incorporate the interaction history into subsequently constructed prompt sentences to maintain narrative continuity.

15. The system according to claim 14, wherein the circuitry is configured to retrieve, from the interaction history, a previously generated narrative segment and to include the previously generated narrative segment as context in a subsequently constructed prompt sentence.

16. The system according to claim 1, wherein the circuitry is configured to receive an operation input from the terminal device during generation of the generated-document text data and to modify the prompt sentence or the generation conditions based on the operation input.

17. The system according to claim 1, wherein the circuitry is configured to analyze character information of the completed document to extract scene information identifying an appearing entity that does not have a main role, generate viewpoint information centering on the appearing entity based on the scene information, and generate a prompt sentence incorporating the viewpoint information so as to cause the generative neural network model to generate a narrative from the viewpoint of the appearing entity as a main character.

18. A system comprising:
circuitry configured to:
receive, via a communication interface coupled to a packet-switched network, identification information of a completed document from a terminal device;
retrieve final-part text data of the completed document from a storage medium based on the identification information;
apply a natural language processing pipeline to the final-part text data to generate analysis information comprising subject information, entity relationship information, and occurrence-frequency scores for appearing entities;
construct a structured prompt sentence for a generative neural network model by encoding the subject information, the entity relationship information, summary information of the final-part text data, and a title of the completed document;
transmit the structured prompt sentence and generation conditions to the generative neural network model via a network interface and receive generated-document text data;
apply content-checking processing to the generated-document text data to evaluate coherence and policy compliance, apply formatting processing to produce display-structured data, and transmit the display-structured data to the terminal device; and
obtain emotion-state information of a user from an emotion recognition function, determine an emotion label and an emotion intensity value from the emotion-state information, and update at least one of the prompt sentence and the generation conditions based on the emotion label and the emotion intensity value.

19. The system according to claim 18, wherein the circuitry is configured to identify a low-prominence entity among the appearing entities based on the occurrence-frequency scores, incorporate viewpoint information centered on the low-prominence entity into the structured prompt sentence, and control the generative neural network model to generate the generated-document text data from a new viewpoint in which the low-prominence entity is treated as a main entity.

20. A method comprising:
receiving, via a communication interface coupled to a packet-switched network, identification information of a completed document from a terminal device;
retrieving, from a storage medium, final-part text data of the completed document based on the identification information;
analyzing the final-part text data using a natural language processing algorithm to generate analysis information comprising subject information of the completed document and relationship information between appearing entities;
constructing a prompt sentence for a generative neural network model based on the analysis information and the final-part text data, the prompt sentence encoding the subject information, the relationship information, and summary information;
transmitting the prompt sentence and generation conditions to the generative neural network model and acquiring generated-document text data from the generative neural network model;
executing formatting processing and content-checking processing on the generated-document text data to generate display-structured data, and transmitting the display-structured data via the communication interface to the terminal device; and
obtaining emotion-state information of a user and modifying, based on the emotion-state information, at least one of the prompt sentence and the generation conditions so as to adjust at least one of narrative development, writing style, and length of the generated-document text data.
